(19) United States
(12) Patent Application Publication
(10) Pub. No.: US 2007/0226320 A1
(43) Pub. Date: Sep. 27, 2007

(54) Device, System and Method for Storage and Access of Computer Files

(76) Inventors: Yuval Hager, Yavneel (IL); Emil Rasamat, Kfar Yona (IL); Divon Lan, Mountain View, CA (US); Michael Adda, Dimona (IL); Michael Kipnis, Fair Lawn, NJ (US)

Correspondence Address: PEARL COHEN ZEDEK LATZER, LLP, 1500 BROADWAY 12TH FLOOR, NEW YORK, NY, 10036, US

(21) Appl. No.: 10/577,488

(22) PCT Filed:
(86) PCT No.: PCT/IL04/00991

Related U.S. Application Data
(60) Provisional application No. 60/515,664, filed on Oct. 31, 2003.

(51) Int. Cl. G06F 13/14

(52) U.S. Cl. 709/219

(57) ABSTRACT

Briefly, some embodiments of the invention provide, for example, devices, systems and methods for storage and access of computer files. A method in accordance with an embodiment of the invention may include, for example, receiving from a remote site a request to access a first file having a plurality of blocks, said request having a pre-defined format encapsulating an original request of a client of a synchronous client-server system and in accordance with a pre-defined file system; determining, for each of at least some of said plurality of blocks, a differential portion representing a difference between each said block and a corresponding block of a second file; and sending said differential portion to said remote site.

### PRIOR APPLICATIONS DATA

The present application claims priority and benefit from prior U.S. Provisional Patent Application No. 60/515,664, entitled “Device, System and Method for Storage and Access of Computer Files”, filed on Oct. 31, 2003 and incorporated herein by reference. Additionally, the present application is a continuation-in-part of, and claims priority and benefit from, prior U.S. patent application Ser. No. 09/999,241, entitled “Method and System for Differential Distributed Data File Storage, Management and Access”, filed on Oct. 31, 2001 and incorporated herein by reference; which in turn claims priority and benefit from prior U.S. Provisional Application No. 60/271,943, entitled “Method and System for Differential Distributed Data File Storage, Management and Access”, filed on Feb. 28, 2001 and incorporated herein by reference.

### FIELD OF THE INVENTION

The present invention relates to data storage, data management and data access. More specifically, the present invention relates to devices, systems and methods for efficient storage and transfer of computer data over a Wide Area Network (WAN).

### BACKGROUND OF THE INVENTION

In some organizations, computer platforms may be located in various sites, offices and branches, which may be physically separated by long distances. For example, a user may wish to use a first computer platform located in a first site, to access or modify a computer file stored on a second computer platform in a second, remote site. Some file systems may allow sharing of computer files over a Wide Area Network (WAN). For example, an Enterprise File Server (EFS) may use a network filesystem, e.g., Common Internet File System (CIFS) or Network File System (NFS), to allow sharing of its computer files over a computer network.

However, a Wide Area Network (WAN) may suffer from bandwidth and round-trip latency limitations. Furthermore, a WAN may suffer from other problems associated with using a conventional network filesystem when operating over a longer physical distance, for example, when operating over the Internet as a WAN.

### SUMMARY OF THE INVENTION

Some embodiments of the invention may provide devices, systems and method for storage and access of computer files and data.

In some embodiments, a system may include a network, e.g., a WAN having a server and a client, and one or more caching devices connected between the client and the server. The caching devices may store one or more versions of files, or portions of files (“blocks”), transferred over the network between the server and the client and vice versa. In some embodiments, if the client requests a file which was already stored in a local caching device, the file may be transferred to the client from the local caching device instead of from the server. In some embodiments, if a file stored in the caching device is a non-updated version of a corresponding file stored in the server, the caching device may calculate, or request another caching device to calculate, a differential portion (a “Delta” or a “Diff”), allowing the client or another caching device to reconstruct the requested file using the differential portion and the non-updated version.

A method in accordance with some embodiments may include, for example, receiving from a remote site a request to access a first file having a plurality of blocks, said request having a pre-defined format encapsulating an original request of a client of a synchronous client-server system and in accordance with a pre-defined file system; determining, for each of at least some of said plurality of blocks, a differential portion representing a difference between each said block and a corresponding block of a second file; and sending said differential portion to said remote site.

In some embodiments, the method may further include, for example, reconstructing said first file at said remote site based on said differential portion and said second file.

In some embodiments, the method may further include, for example, identifying one or more blocks of said first file with a unique ID corresponding to a content of said one or more blocks.

In some embodiments, the method may further include, for example, identifying one or more blocks of said first file with a hash value of the contents of said one or more blocks.

In some embodiments, the method may further include, for example, receiving from said remote site a lock request when said remote site requests to modify said first file.

In some embodiments, the method may further include, for example, determining whether said second file correlates to said first file based on a heuristic.

In some embodiments, the method may further include, for example, monitoring a modification performed on said first file.

In some embodiments, the method may further include, for example, receiving from said remote site a request to access said first file using a global name space of said client-server system.

In some embodiments, the method may further include, for example, receiving from said remote site a request for authentication using a pass-through challenge-response mechanism.

In some embodiments, the method may further include, for example, processing a set of credentials for authentication.

In some embodiments, the method may further include, for example, storing said differential portion in a directory for later retrieval of a version of said first file.

In some embodiments, the method may further include, for example, setting a read-only access permission to a files is said remote site if said remote site is non communicating.

In some embodiments, the method may further include, for example, receiving said request within a backup consolidation process.

In some embodiments, the method may further include, for example, storing in a cache at least one block of said first file, and/or storing in a cache at least one block of said second file.

In some embodiments, the method may further include, for example, storing said differential portion in a directory associated with archived versions of said first file.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a Wide Area Network (WAN) in accordance with exemplary embodiments of the invention;

FIG. 2 is a schematic block diagram illustration of a management unit in accordance with exemplary embodiments of the invention;

FIG. 3 is a schematic block diagram illustration of an Automatic Resource Tuning (ART) module in accordance with exemplary embodiments of the invention;

FIG. 4 is a schematic block diagram illustration of a data structure in accordance with exemplary embodiments of the invention; and

FIG. 5 is a schematic block diagram illustration of a directories structure in accordance with exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following description, various aspects of the invention will be described. For purposes of explanation, specific configurations and details are set forth in order to provide a thorough understanding of the invention. However, it will also be apparent to one skilled in the art that the invention may be practiced without the specific details presented herein. Furthermore, well-known features may be omitted or simplified in order not to obscure the invention.

Some embodiments of the invention may use and/or incorporate methods, devices and/or systems as described in U.S. patent application Ser. No. 09/999,241, United States Patent Application Publication No. 2002/0161860, entitled “Method and System for Differential Distributed Data File Storage, Management and Access”, published on Oct. 31, 2002, which is hereby fully incorporated by reference. However, the scope of the present invention is not limited in this regard, and embodiments of the present invention may use and/or incorporate other suitable methods, devices and/or systems.

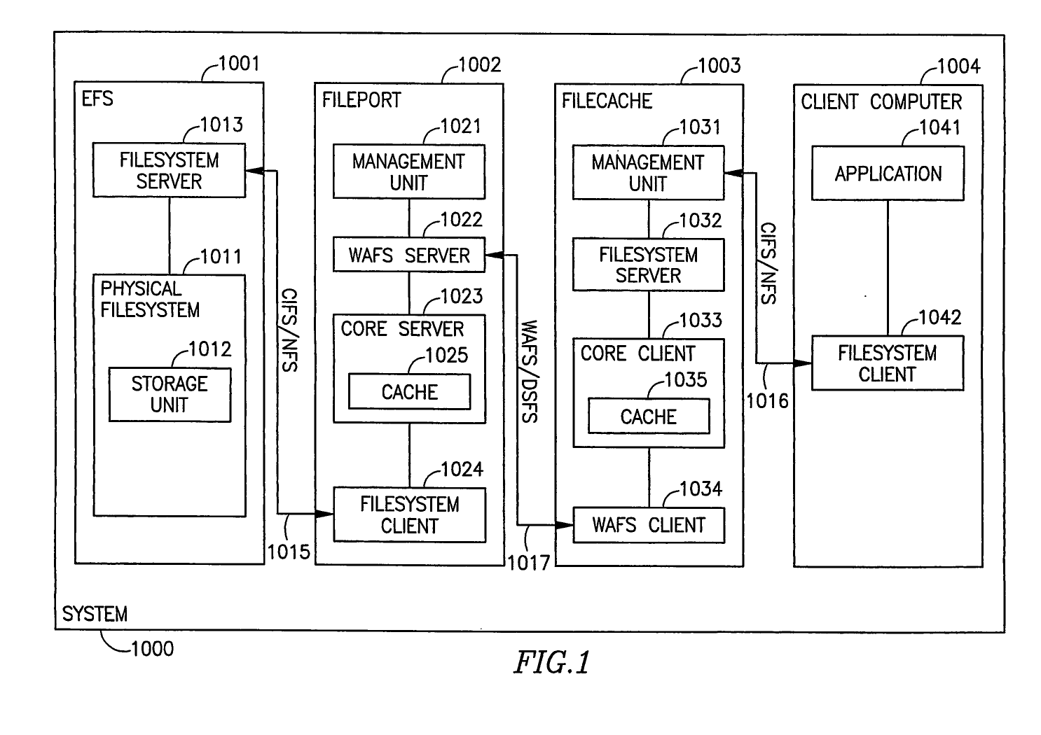

FIG. 1 schematically illustrates a Wide Area Network (WAN) 1000 in accordance with some embodiments of the present invention. System 1000 may include, for example, an Enterprise File Server (EFS) 1001 (or a plurality thereof), a FilePort 1002 computer 1002 (or a plurality thereof), a FileCache 1003 computer 1003 (or a plurality thereof), and one or more client computers such as, for example, client computer 1004. System 1000 may include various other suitable components and/or devices, which may be implemented using any suitable combination of hardware components and/or software components. System 1000 may be referred to as “the network” and/or “the system”.

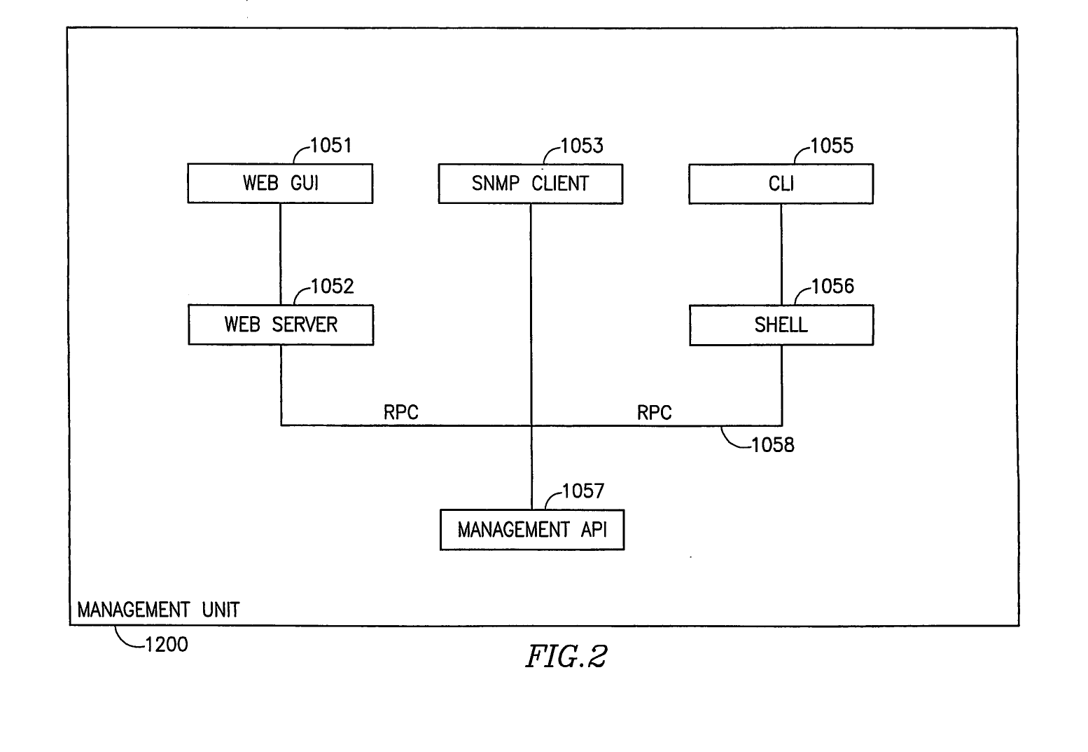

EFS 1001 may include, for example, a server or computing platform having a physical file system 1011 and a filesystem server 1013. Physical file system 1011 may include, for example, a storage unit 1012, e.g., a hard disk drive and/or other suitable storage units or memory units. Filesystem server 1013 may include, for example, a server utilizing Common Internet File System (CIFS) or Network File System (NFS). EFS 1001 may also export a file system which may physically reside in another component or device. FilePort 1002 may include, for example, a computing platform having a management unit 1021, a Wide Area File System (WAFS) server 1022 (which may be also referred to as Distributed System File Server (DSFS) server), a core server 1023, and a filesystem client 1024. Management unit 1021 may include, for example, components and/or sub-units as described below with reference to FIG. 2. WAFS server 1022 may include, for example, a computing platform able to serve, create, send and/or transfer a data item, a file, a block or other suitable objects in accordance with embodiments of the present invention. Core server 1023 may include, for example, a computing platform able to analyze, forward, compute Delta and compress a data item. Core server 1023 may include a cache 1025, e.g., a suitable storage unit or memory unit. Filesystem client 1024 may include, for example, a client utilizing CIFS, NFS, NCP or AppleTalk.

FileCache 1003 may include, for example, a computing platform having a management unit 1031, a file system server 1032, a core client 1033, and a WAFS client 1034 (which may also be referred to as DSFS client). Management unit 1031 may include, for example, components and/or sub-units as described below with reference to FIG. 2. Core client 1033 may include, for example, a computing platform able to analyze, forward, compute Delta and compress a data item. WAFS client 1034 may include, for example, a computing platform able to request and/or receive a data item, a file, a block or other suitable objects in accordance with embodiments of the present invention. Filesystem server 1032 may include, for example, a server utilizing CIFS or NFS.

Client computer 1004 may include, for example, a computing platform having a client application 1041 and a filesystem client 1042. Client application 1041 may include, for example, one or more software applications, e.g., Microsoft Word, Microsoft Excel, Microsoft PowerPoint, Adobe Acrobat, Adobe Photoshop, or the like. Filesystem client 1042 may include, for example, a client utilizing CIFS or NFS.

In some embodiments, filesystem client 1024 of FilePort 1002 and filesystem server 1013 of EFS 1001 may be able to communicate via a link 1015, which may utilize, for example, CIFS or NFS. Similarly, filesystem client 1042 of client computer 1004 and filesystem server 1032 of FileCache 1003 may be able to communicate via a link 1016, which may utilize, for example, CIFS or NFS. In some embodiments, WAFS server 1022 of FilePort 1002 and WAFS client 1034 of FileCache 1003 may be able to communicate via link a 1017, which may utilize a method of distributed data transfer (e.g., WAFS) in accordance with embodiments of the present invention.

It is noted that links 1015, 1016 and/or 1017 may be wired and/or wireless, and may include, for example, one or more links which may be connected in serial connection and/or in parallel. In one embodiment, for example, links 1015 and 1016 may be Local Area Network (LAN) links, and link 1017 may include one or more links utilizing the Internet or other global communication network.

Some embodiments of the present invention may decrease or minimize the amount of data that may be transferred across link 1017. This may be achieved, for example, using a version controlled file system or a version controlled data transfer and storage scheme utilized by FilePort 1002 and FileCache 1003. In some embodiments, substantially each file, directory, or file portion (“block”) stored in system 1000 may have an identifier, e.g., a Version Number (Vnum), associated with it. The Vnum may include a number that may increase with every change of the file, directory or block; and each Vnum may be associated with a specific version of the corresponding file, directory or block.

In some embodiments, client computer 1004 and/or FileCache 1003 may be referred to as a “Client Entity”, e.g., as they may request to perform an operation on a certain file, directory or block; and FilePort 1002 and/or EFS 1001 may be referred to as a “Server Entity”, e.g., as they may receive a request from a Client Entity and either serve requested file to the Client Entity or otherwise instruct Client Entity with regard to further operations.

For example, in some embodiments, client computer 1004 may require access to a file, denoted File1, which may be stored on EFS 1001. Client computer may request File1 from FileCache 1003, which in turn may request File1 from FilePort 1002, which in turn may request File1 from EFS 1001. In response, EFS 1001 may send File1 to FilePort 1002, which may store a copy of File1 and also send it to FileCache 1003, which in turn may store a copy of File1 and also send it to client computer 1001.

In one embodiment, each copy of File1 may have a Vnum associated with it. For example, FilePort 1002 and/or FileCache 1003 may maintain a cache of part or all or substantially all the files accessed during their operation, and a Vnum may be associated with substantially each file, block or directory saved in the cache.

When a Client Entity requires to access a file, which may be stored in a Server Entity of system 1000, the Client Entity may send to the Server Entity a file request and the Vnum of the file that may be already stored in the Client Entity. If the Server Entity has a stored file, whose Vnum is not greater as that of the file stored on the Client Entity, then the Server Entity may indicate so to the Client Entity, and no further data transfer may be necessary from the Server Entity to the Client Entity, as the Client Entity may use the file stored in it instead of obtaining the file from the Server Entity. Alternatively, if the Server Entity has a stored file whose Vnum is greater than the Vnum of the file stored in the Client Entity, than the Server Entity may send to the Client Entity data corresponding to the content difference (denoted herein as “Diff” or “Delta”) between the two files, such that the Client Entity may be able to reconstruct the requested file from the Delta and the file stored on the Client Entity.

For example, FileCache 1003 may request a file from FilePort 1002 by sending a request for File1 and an indication that FileCache 1003 currently stores a copy of File1 having a Vnum equal to 3. FilePort 1002 may receive the request and may process it. For example, if the Vnum of File1 stored in FilePort 1002 is not greater than 3, then FilePort 1002 may not send to FileCache 1003 a copy of File1, but rather, FilePort 1002 may send to FileCache 1003 an indication that the copy of File1 stored in FileCache 1003 is a valid or an updated copy which FileCache 1003 may access. Alternatively, if the Vnum of File1 stored in FilePort 1002 is greater than 3, then FilePort 1002 may send to FileCache 1003 the Delta between the version of File1 stored in FilePort 1002 and the version of File1 stored in FileCache 1003, as well as an indication that FileCache 1003 may need to reconstruct File1 using the Delta and the version of File1 stored in FileCache 1003.

In some embodiments, a suitable algorithm, scheme or process (“Differential Algorithm”) may be used to create a Delta between two versions of a file, a directory or a block For example, the Delta between the two versions may include one or more Deltas, e.g., “patches”, between a first version and a second, more recent version. The requesting unit may then apply the one or more patches or Deltas, sequentially, to the file version in its cache, thereby updating the Vnum accordingly.

In some embodiments, a differential file system may be used. For example, an original request to access a file, e.g., originating from client computer 1004, may be intercepted, analyzed, modified, re-formatted or encapsulated in or as a modified request in accordance with a pre-defined protocol of file system.

In some embodiments, a Server Entity may store a file using a pre-defined format. For example, in one embodiment, a file may be stored by storing a base block and one or more Delta blocks. The base block may include base data of the file and base Vnum of the file, e.g., the Vnum of the file having no Delta blocks. Subsequent Delta blocks may be added to the base block, thereby increasing the Vnum of the file incrementally.

In some embodiments, an operation in which newly written data is sent to FilePort 1002 may be referred to as a “commit” operation. Data sent can be a complete file, a complete block, a Delta, or other indication or marking of the file data to FilePort 1002.

In some embodiments, when a Client Entity requires to modify data of a certain file, after verifying that the latest version of the file has been obtained, the Client Entity may produce the Delta (e.g., using a Differential Algorithm) between the latest version and the new version of the file being modified by the Client Entity. The Client Entity may then send that Delta to the Server Entity, which may apply or appends the Delta to the latest version of the file stored in the Server Entity, and may incrementally increase the Vnum associated with that file.

In accordance with some embodiments, after a file is modified at a Server Entity, the Client Entities that need to read that modified file may read only the relevant Delta portions and may apply them to a previously stored file version.

In some embodiments, different versions of portions of a file, or of a block of a file, may be sent to different users or client computers. For example, a Server Entity (EFS 1001 and/or FilePort 1002) may store a file F having a Vnum equal to 5. A first client entity (e.g., FileCache 1003 and/or client computer 1004) may not have file F stored locally, and therefore the Server Entity may send to that Client Entity the entire file F. A second Client Entity may have file F stored locally, having a Vnum equal to 2, and therefore the Server Entity may send to that Client Entity the Delta between the two versions of file F, namely, between Vnum 5 and Vnum 2. A third Client Entity may have file F stored locally, having a Vnum equal to 5, and therefore the Server Entity may avoid sending file F or a Delta to that Client Entity, or may indicate to that Client Entity to use the local version of file F which is up-to-date.

In some embodiments, components of system 1000 may be physically located in various locations, sites, branches and/or offices of an organization or a plurality of organizations. For example, EFS 1001 and FilePort 1002 (or a Server Entity) may be located in a headquarters office, a head office or a central office of an organization; EFS 1001 and FilePort 1002 may be located in physical proximity to each other, or may be connected to each other on the same LAN. In one embodiment, EFS 1001 and FilePort 1002 may be implemented using one or more suitable software components and/or hardware components. It is noted that in some embodiments, FilePort 1002 and/or FileCache 1003 may be a stand-alone device or a “Plug and Play” (PnP) device, such that they may operate without a software or hardware modification to client computer 1004 and/or to EFS 1001.

Similarly, in some embodiments, FileCache 1003 and client computer 1004 (or a Client Entity) may be located in a remote office, a back office, a branch office of an organization or at an employee's residence. For example, FileCache 1003 and client computer 1004 may be located in physical proximity to each other, or may be connected to each other on the same LAN. In one embodiment, FileCache 1003 and client computer 1004 may be implemented using one or more suitable software components and/or hardware components.

In some embodiments, FilePort 1002 and FileCache 1003 may be used to facilitate, speed-up, enhance or improve the transfer of data, files or blocks from EFS 1001 to computer client 1004, or vice versa For example, FilePort 1002 and/or FileCache 1003 may store a copy of a file transferred through them or by them. Later, FilePort 1002 and/or FileCache 1003 may be requested to transfer a file or to obtain a file, for example, on behalf of computer client 1004. In some cases, FilePort 1002 and/or FileCache 1003 may detect that the requested file has not been modified at EFS 1001 since it was last stored in the cache of FilePort 1002 and/or FileCache 1003. The requested file may be sent to computer client 1004 from FilePort 1002 and/or FileCache 1003, thus saving a time-consuming, bandwidth-consuming and resource-consuming access to EFS 1004.

For example, in some embodiments, FilePort 1002 and/or FileCache 1003 may compare the Vnum, a hash function value, a content and/or a property of a requested file, to a corresponding Vnum, a hash function value, content and/or property of the requested file which is stored on EFS 1001. FilePort 1002 and/or FileCache 1003 may otherwise analyze and/or compare files, blocks, directories and/or traffic passing through FilePort 1002 and/or FileCache 1003, to detect that a requested file, block or directory is identical, similar or non-identical to another file, block or directory stored in the cache of FilePort 1002 and/or FileCache 1003, and, accordingly, to transfer an entire file, to transfer one or more Deltas, or to transfer one or more indications of the analysis results.

In some embodiments, the analysis or comparison may further allow FilePort 1002 and/or FileCache 1003 to calculate, compute and/or produce a Delta portion, which may include data indicating the modifications that need to be done to a first file in order to create a second file.

In some embodiments, FileCache 1003 may be installed, for example, at a remote branch office of the enterprise having the EFS 1001. FileCache 1003 utilize CIFS or NFS protocol and thus may appear on the remote site's LAN as a Windows or a UNIX file server. In some embodiments, rather than serving files from its own hard-drive (as a regular file server does), the FileCache 1003 may utilizes the DSFS protocol in order to fetch the requested files from the EFS 1001, over the WAN, in an efficient way. For example, FileCache 1003 may connect over a Transmission Control Protocol/Internet Protocol (TCP/IP) channel or a UDP/IP channel to FilePort 1002, installed at a corporate data center. Upon receiving a request from the FileCache 1003, the FilePort 1002 may turn to the actual file server (e.g., EFS 1001), acting as a Windows client on behalf of the actual user that originated the request (e.g., client computer 1004), and obtain the needed information. In some embodiments, FilePort 1002 and FileCache 1003 may be substantially transparent to end-users, which may continue to use the same tools and applications they are accustomed to use when accessing Windows file servers.

In some embodiments, system 1000 may be managed using a dedicated management station, e.g., using an Internet browser. In one embodiment, each component of system 1000 may be managed using an individual web interface. In some embodiments, both the center and the remote locations may be deployed using a no-single-point-of-failure architecture, e.g., in order to achieve high availability. In some embodiments, the architecture provides for a many-to-many relationship, for example, a single FilePort 1002 may serve a plurality of remote sites, each with its own FileCache 1003, and a single FileCache 1003 at a remote site can access data through multiple FilePort 1002 devices, each at a potentially different data center.

FIG. 2 schematically illustrates a block diagram of a management unit 1200 in accordance with some embodiments of the present invention. Management unit 1200 may be an example of management unit 1021 of FIG. 1, and may be operatively connected to, or an integrated part of, FilePort 1002. Management unit 1200 may be an example of management unit 1031 of FIG. 1, and may be operatively connected to, or an integrated part of, FilePort 1002.

Management unit 1200 may include, for example, a web Graphic User Interface (GUI) 1051 that may be operatively connected to a web server 1052; a Simple Network Management Protocol (SNMP) client 1053; a Command Line Interface (CLI) 1055 that may be operatively connected to a shell 1056; and a management Application Program Interface (API) 1057. Web server 1052, SNMP client 1053 and/or shell 1056 may be operatively interconnected, and/or operatively connected to management API 1057, for example, using Remote Procedure Call (RPC) 1058.

Management unit 1200 may be used, for example, to manage or control one or more features or modules of system 1000, FileCache 1003 and/or FilePort 1002, or to set or modify one or more operational parameters of FileCache 1003 and/or FilePort 1002. Referring again to FIG. 1, the components of system 1000 may be implemented using a suitable combination of software components and/or hardware components. For example, in one embodiment, FileCache 1003 may be implemented using a Personal Computer (PC) over Linux operating system, e.g., Linux kernel versions 2.2.16, 2.2.19, 2.4.18 or 2.4.20, or Red Hat Linux versions 7.0, 7.3 and 9.0. Other suitable Linux versions, or other suitable operating systems e.g. Microsoft Windows or Sun Solaris, may be used.

In some embodiments, FileCache 1003 may further include a modified version of Samba 3.0.0 in user mode application. Some modifications to Samba may include, for example, removal of support for batch opportunistic locks, addition of support for sharing mode (which may exist under Windows and not under Unix environments), addition of various hooks for measurement of statistics, access control lists handling, and file creation time setting adjustments.

In some embodiments, at least a portion of software code running on FileCache 1003 may run as a Linux kernel file system. In one embodiment, for example, a NFS server (e.g., in filesystem server 1032) and/or a Samba server (e.g., in filesystem server 1032) may use the core client 1033 as a Linux file system.

In some embodiments, substantially all system calls may be implemented inside the kernel mode, for example, using kernel API. This may be performed, for example, instead of using a user mode agent, e.g., to achieve debugging simplicity and/or better general system stability.

In some embodiments, some or substantially all communications in system 1000 may be performed over a TCP/IP channel. In one embodiment, some communications may use other suitable protocols or channels, for example, “I-am-alive” requests (e.g., as described herein) may be sent using a User Datagram Protocol (UDP).

In some embodiments, FilePort 1002 may run in a user-mode, and may use TCP/IP to communicate with EFS 1001. In some embodiments, a CIFS client may be used, and a NFS client may be implemented, for example, by mounting a NFS share on a server and using file system calls. In alternate embodiments, a stand-alone NFS client may be used, e.g., to allow wider access to tune protocol parameters.

In some embodiments, FileCache 1003 may be operatively connected to, and may communicate with, multiple users and/or multiple client computers 1004. In some embodiments, FileCache 1003 may be operatively connected to, and may communicate with, multiple FilePort 1002 devices. In some embodiments, FilePort 1002 may be operatively connected to, and may communicate with, multiple EFS 1001 devices and/or multiple FileCache 1003 devices. In some embodiments, system 1000 may allow “many-to-many” access, e.g., using “contexts” and/or “sessions” as described herein.

In accordance with some embodiments, a “context” may include, for example, a logical link between one FileCache 1003 and one FilePort 1002. For example, a context may be defined by an ID. This ID may be unique (e.g., across system 1000) and may be factory-generated or deployment-generated.

In some embodiments, one or more devices in system 1000 (e.g., FileCache 1003 and/or FilePort 1002) may store a list of valid contexts. In one embodiment, for example, FileCache 1003 may periodically send one or more “I am alive” datagrams (or signals, packets, frames or messages) to substantially all FilePort 1002 devices that exist in its contexts list, e.g., to validate its contexts on the FilePorts 1002 side.

In accordance with some embodiments, a “session” may include, for example, a CIFS/NFS session between a user of client computer 1004 and EFS 1001. A session may be tunneled via a FileCache 1003/FilePort 1002 pair, and may substantially always be served through the same pair of FileCache 1003/FilePort 1002 and, therefore, may belong to a certain context. When a context becomes invalid, for substantially any reason, all the sessions associated with that context may be deleted or destroyed on all relevant devices.

In some embodiments, for example, branch level security may be used by FileCache 1003 to create one session per one link between FilePort 1002 and EFS 1001. This session may belong, for example, to a specially defined branch user.

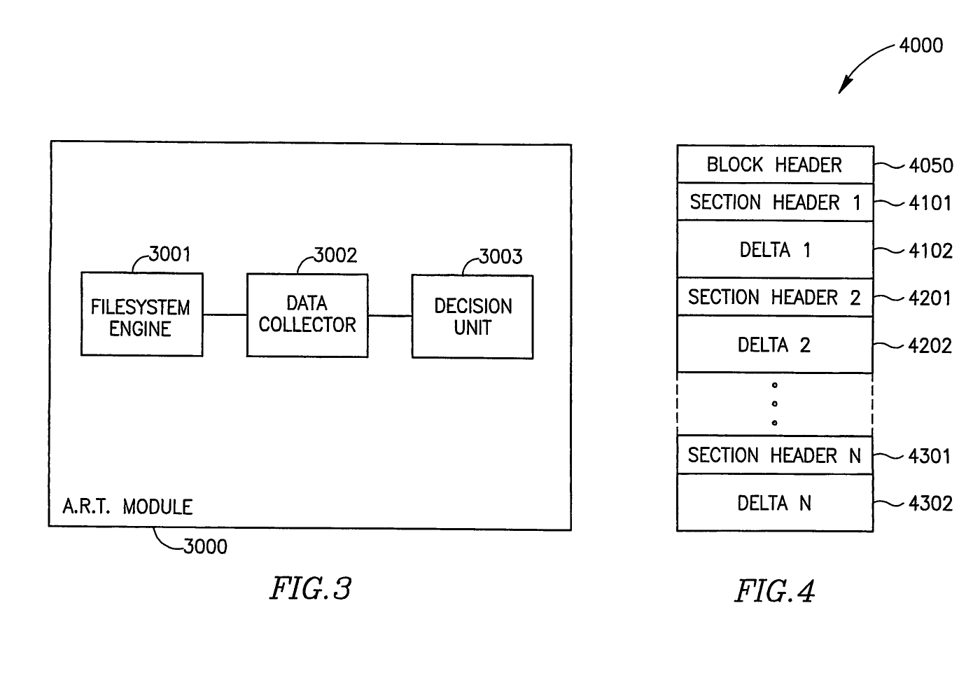

FIG. 3 schematically illustrates a block diagram of an Automatic Resource Tuning (ART) module 3000 in accordance with some embodiments of the invention. ART module 3000 may be used, for example, to dynamically and/or automatically enhance or optimize the performance of system 1000 and/or of one or more components of system 1000. ART module 3000 may be implemented, for example, as part of FilePort 1002, FileCache 1003, management unit 1200, or other software components and/or hardware components.

In some embodiments, ART module 3000 may include, for example, a filesystem engine 3001, a data collector 3002, and a decision unit 3002, which may be implemented using software components and/or hardware components.

In some embodiments, filesystem engine 3001 may perform substantially all the filesystem operations; data collector 3002 may collect information related to the operation of filesystem engine 3001; and decision unit 3003 may use a decision algorithm to determine or select the best way, or a better way, to perform a certain operation, based on the collected data.

File system engine 3001 may, for example, serve file system requests; compress and decompress data, or encode and decode data; calculate a Delta between files or blocks; patch or update files or blocks, or rebuild a file using one or more Deltas; and/or handle a plurality of users, files and/or sessions substantially simoultanouesly.

Data collector 3002 may collect and store data, for example: available bandwidth; roundtrip latency; available CPU and memory resources; compression efforts (e.g., in terms of CPU usage, memory usage and time); compression ratios; Delta production efforts (e.g., in terms of CPU usage, memory usage and time); Delta ratios and other Delta properties; user or application priorities; response times from various entities, e.g., from EFS 1001; data regarding service level required by a user or an application; data and ratios regarding the usage (“cache-hit”) or non-usage (“cache-miss”) of certain files and/or blocks within Cache 1025 or Cache 1035; and other suitable data items.

Upon receiving a request (e.g., from client computer 1004), decision unit 3003 may analyze the data collected by data collector 3002, and may anticipate the effort and gain in substantially each route of operation which may be carried out. Decision unit 3003 may determine, for example, a substantially best mode, or a substantially most efficient mode, to respond to the request or to serve the user of client computer 1004. In some embodiments, decision unit 3003 may use one or more pre-defined rules, conditions, criteria or algorithms in order to make the determination.

In some embodiments, for example, decision unit 3003 may estimate that compressing a requested file and sending the compressed file may take a longer time period in comparison to sending the request file without compressing it. In such case, for example, decision unit 3003 may determine that the requested file be sent without compression.

In some embodiments, for example, decision unit 3003 may estimate that sending a Delta may have a relatively high risk (e.g., a risk greater than a pre-defined threshold value) of “cache-miss” at the receiving entity. In such case, for example, decision unit 3003 may determine that the entire requested file be sent, and that a Delta may not be produced or sent.

In some embodiments, for example, decision unit 3003 may determine that a user or an application having high priority is currently using certain network resources (e.g., CPU or memory). In such case, for example, decision unit 3003 may instruct that compression operations and/or Delta production operations be avoided.

In some embodiments, for example, decision unit 3003 may determine that a service level required by a user or an application may not be achieved. In such case, for example, decision unit 3003 may notify the administrator of system 1000, notify the relevant user, or perform other suitable operations. In some embodiments, for example, if the application allows, decision unit 3003 may select to work asynchronously in order to achieve the requested service level.

Referring back to FIG. 1, in some embodiments, system 1000 may utilize a block-based engine or system as described herein. In order to optimize the traffic over the WAN, the internal cache handling and the Delta calculation, a file or a plurality of files may be divided into one or more blocks. In some embodiments, these blocks may be the minimal data unit for transport and caching, and may be either of constant or variable size. In other embodiments, the block size may be dynamically set per substantially each file during the system operation (e.g., according to run time collected information, preset data (for example, network conditions) and user configuration), and communicated to the other end using the predefined protocol.

In some embodiments, for example, constant size blocks may be used (e.g., 128 KiloBytes per block). In alternate embodiments, other suitable block sizes may be used, or dynamic variable-size blocks may be used.

In some embodiments using blocks, FileCache 1003 may obtain from FilePort 1002 substantially only the blocks that may contain the data that was requested by client computer 1004. In some embodiments using blocks, FileCache 1003 may send back to FilePort 1002 substantially only the blocks that were modified by client computer 1004.

Additionally or alternatively, in some embodiments, since FileCache 1003 may utilize an application-based read-ahead prediction as described herein, and therefore FileCache 1003 may request from FilePort 1002 a certain block of a file. The specific block requested may be based on the analysis done by the system to determine which blocks will probably be requested by the user in the future. This analysis may be based on the file type, but may be adjusted during run time, e.g., by collecting and analyzing “hit” and “miss” ratios. The time to access the block may not be dependent on the file size or the number of blocks in the file. As a result, if the prediction was untapped, then the only associated overhead may be the single block treatment. Alternatively, when several FileCache 1003 devices are working with the same FilePort 1002 on the same file, the block-based system may allow to refine Delta exchange, so that FilePort 1002 may notify its FileCache 1003 devices which block was modified. In some embodiments, Deltas may be determined, computed, sent and/or processed on a file basis; in alternate embodiments, Deltas may be determined, computed, sent and/or processed on a block basis or on a block-by-block basis.

In some embodiments, underlying layers of Windows clients software (e.g., CIFS client) may have a non-configurable timeout, which some filesystem operations (e.g., open, close or move) may not overpass. In some embodiments, the timeout may be short, for example, the timeout may be between approximately 60 to 180 seconds, e.g., depending on the type and version of Operating System used. In some embodiments, the block size may be set such that a block may be sent over link 1017 within less than the timeout incorporated by the user operating system; for example, in one embodiment, network bandwidth multiplied by the timeout divided by two may be used in the determination of block size.

In some embodiments, system 1000 may utilize version management of files, directories or blocks. For example, substantially each block and file may have a version number associated with it and/or attached to it at substantially any point in time. When a file is modified, the version number may be modified accordingly. When FileCache 1003 requests a file, it adds to the request information describing which version of the requested file is already cached at FileCache 1003. If the version of the file stored in EFS 1001 is different, then FilePort 1002 may send to FileCache 1003 an update in the form of a Delta between the two versions.

Some embodiments may be able to identify and mark modifications to even huge files (e.g., files of hundreds or thousands of MegaBytes). In one embodiment, this may be performed in O(1) complexity, without a need to update or check all the blocks of a file.

In some embodiments, a versioning mechanism may be used to manage versions, e.g., by FileCache 1003 and/or FilePort 1002. Both of these entities may need to handle received requests for data, and either responding from the cache or forwarding a suitable request to the other entity. Therefore, the file and block versioning mechanism may be substantially similar or identical in both FileCache 1003 and/or FilePort 1002, thereby allowing an efficient design and implementation of system 1000.

In some embodiments, substantially each block may be stored in the cache and may be transmitted separately. Therefore, in one embodiment, substantially each block may have a version number. In addition, in order to distinguish between different versions of files, each file may have its own version number.

In some embodiments, substantially each file stored may have a pair of numbers that compose the version number (vState): an internal Vnum and an external Vnum. An internal Vnum may be, for example, the last version number of the opened file that was changed by the current entity. An external Vnum may be, for example, the last known version number of the file which was changed either by the current or a different entity.

In some embodiments, blocks whose Vnum is between the internal Vnum and the external Vnum of the file, are treated as valid blocks.

In some embodiments, when a file is opened, if the file was changed at the next entity, then the file's external Vnum and internal Vnum may be increased.

In some embodiments, when or before a block is read, the block may be checked for validity. If the block is valid, then the block may be read from the cache. If the block is not valid (“stale”), then an updated block may be requested from the next entity, and the block's Vnum may be updated accordingly.

In some embodiments, when a block is written or modified, the Vnum of the block may be updated accordingly, and a Delta portion or a complete file may be sent to the next entity (e.g., based on Delta production algorithm).

In some embodiments, system 1000 may use a block-based system, e.g., having “Dirty” blocks (e.g., blocks that were modified by the user but the data was yet to be sent to the FilePort 1002 and the EFS 1001) and “Plain” blocks (e.g., non-modified blocks, or blocks with previously known data). In some embodiments, when the file is closed, the file's data and metadata is stored in the Plain cache. FileCache 1003 substantially always uses the local block version for read and write operations, and this local block may be either the Plain block or the Dirty block.

In some embodiments, pre-defined rules may apply to handling Dirty and Plain blocks and metadata on FileCache 1003.

For example, in one embodiment, when FileCache 1003 retrieves the local block version for a read operation, FileCache 1003 may check whether a Dirty version exists, and if the check result if positive, then an indication that the local block is a Dirty block may be returned. Otherwise, FileCache 1003 may check whether the block is a “zero” block (as described herein), and if so, may create a Plain block and fill it with “zero” values. Otherwise, if a Plain block is missing, or expired in the cache, then it may be obtained from FilePort 1003, and the obtained Plain block may be returned as the local block.

In some embodiments, when FileCache 1003 retrieves the local block version for a write operation, FileCache 1003 may check whether a Dirty block version exists. If the Dirty version is missing, then the local block version may be retrieved, e.g., as described above, and a Dirty copy of the plain block may be created and the Dirty block may be returned as the local block. In some embodiments, since all blocks are virtually the same size for each file, the last block size may be noted in accordance with the file's size.

In some embodiments, a read operation of a last block (e.g., when the local block is a Dirty block or when the local block is a Plain block) may be limited by the actual file size, and not by the block size.

In some embodiments, when a file size is set (e.g., using an OS API command such as “SetFileSize” or “truncate”), the size of the last block's Dirty may be updated. In some embodiments, if the file size is increased by more than one block size, the added blocks may contain zero values. In one embodiment, instead of writing a block with zero values, an indication may be made that the block exists and that its content is zero values; such a block may be referred to as a “zero block”. In some embodiments, during a “commit” process, write instructions may be issued substantially only for the blocks that are Dirty. In one embodiment, a file size reduction may result in an immediate commit. During a commit process, if the file size was changed, then a “SetFileSize” (as described above) instruction may be added first.

In some embodiments, after a commit process, since the Dirty data and meta data may be written to the EFS 1001, this data may be considered Plain and thus FileCache 1003 may replace Plain blocks with Dirty blocks and Plain metadata with Dirty metadata. In one embodiment, if there was no Dirty block, and the filesize has changed, then the size of the Plain block may be modified, if needed. When the file is closed, the Plain cache on FilePort 1002 may hold the last known data and metadata of the file.

In some embodiments, FilePort 1002 may write data synchronously, so that FilePort 1002 may not manage Dirty blocks. Instead, FilePort 1002 may handle a Deltas collection substantially per each block.

In some embodiments, one or more rules may apply to handling file blocks and metadata on FilePort 1002. For example, in some embodiments, during a read or write operation, before the Plain block is updated, FilePort 1002 may check whether a block is a “zero” block, and if so, may create a Plain block that contains zero values. In some embodiments, when a file size is set, a new Plain block may be generated for the old last block, and a Delta may be created and stored. In one embodiment, Plain blocks and/or Delta portions, which may be affected as a result of setting a file size, may not be created or deleted; They may be evicted later using the cache eviction algorithm. In some embodiments, when a file's metadata is generated for the first time, a default Bmap value is created as described herein.

In some embodiments, increasing a file size may be completed in O(1) time, regardless of the number of blocks which where added to or removed from the file. In some embodiments, a block may be marked as “zero” (e.g., having zero values as content), or as “old” (e.g., a block that may be discarded by the cache mechanism). Accordingly, in some embodiments, FileCache 1003 and/or FilePort 1002 may use a data item (e.g., a bit mask where each set bit marks a standard—Plain or Dirty—block, and each unset bit marks a “zero” block) included in the file's metadata and referred to as Bmap.

In some embodiments, the Bmap may indicate whether or not the block is a “zero” block. When the file is created, its Bmap may be empty. When the file is reduced or enlarged, its Bmap may be being reduced or enlarged accordingly. Newly added blocks may become zero blocks. When the block is written, a zero mark may be cleared.

In one embodiment, for example, a file may be enlarged; blocks 3 and 4 were added (however, neither Plain blocks nor Dirty blocks are created at this time). If a Dirty version of block 2 exists, it may be enlarged and the Delta may be filled with zeroes. Bmap may be enlarged accordingly; all newly added blocks may be signed as “zero” blocks. The file may be marked as “size changed”, and FilePort 1002 may be notified during the next commit process.

In another embodiment, for example, a file may be truncated; blocks 3 and 4 were removed (however, only superfluous Dirty blocks are deleted; Plain blocks main remain in cache for future Diff usage). If a Dirty version of block 2 exists, it may be truncated. Bmap may be reduced accordingly, and the file may be marked as “size changed”. FilePort 1002 may be notified immediately with the commit process. After the commit process, if there was no Dirty version for block 2, then its Plain may be truncated and stored with a new version number.

In some embodiments, another way to store “zero” information may include a list or map of pairs, for example, “latest stale version number, starting from block number”. The list may be defined with a constant size, for example, 20 entries. When the list is about to be overflowed, the list may be truncated with a pair of “last version number +1, 0”. Old version numbers that could be trusted may be lost, and FileCache 1003 may issue a transaction to FilePort 1002. This list may become a part of the vState of a file's metadata.

In accordance with some embodiments, a collection of Deltas may be managed. FileCache 1003 and/or FilePort 1002 may be able to reconstruct a last file version from a base-version block and from a collection of Deltas (e.g., the collection of [Delta(base version+1) . . . Delta(last version)]. In some embodiments, Delta(n) may refer to the Delta computed between version (n−1) and version n of the file. In some embodiments, FileCache 1003 may initiate the requests, so FileCache 1003 may manage old Deltas in its cache. In some embodiments, FilePort 1002, on the other hand, may manage these Deltas to support multiple FileCache 1003 devices, each one with its own block versions. In some embodiments, the Deltas may be stored per block in a Least Recently Used (LRU) cache and may have a structure similar to an exemplary structure 4000 illustrated schematically in FIG. 4. For example, the cache, or a block, may store data structure 4000 which may include one or more blocks and/or Deltas. Structure 4000 may include, for example, a block header 4050, followed by a first section header 4101 and a first Delta 4102, which may be followed by a second section header 4201 and a second Delta 4202. Further sections and Deltas may be included in structure 4000, for example, consecutively until a last, Nth, section header 4301 followed by a last, Nth, Delta 4302.

In some embodiments, blocks may be referred to, or may be exclusively referred to, or identified or exclusively identified, using unique ID, e.g., a hash on their content. The hash may be a result of any suitable hash algorithm, for example, MD5. Blocks may be treated as “never changing”, and may be stored in a way that enables fast access according to the block hash. For example, all blocks may be saved in a special directory, and the file-name of each block may be, or may include, the block's hash value. In some embodiments, this may be beneficial, for example, with regard to a database, in which most of the time, most of the file may be fixed and only certain portions of it are being changed. Setting the system block size in accordance with the database block or record size may allow further optimization.

In some embodiments, for each file, system 1000 may utilize a list of block hashes, instead of a list blocks. When a file changes, system 1000 may not change the block itself, but use a different block, that may be stored using a different hash. This way, each block may be cached and transferred only once over system 1000; if several files share similar blocks, this similarity may be used, for example, to save bandwidth and cache space.

In some embodiments, when FileCache 1003 needs to read a block, it may send to FilePort 1002 the block number in the file, the hash result, and whether it is cached or not. FilePort 1002 may check the latest version of the file at EFS 1001. If FileCache 1003 has the right hash in the right place, nothing needs to be done besides sending an approval to FileCache 1003. If FileCache 1003 does not have the right hash (for example, if the file has changed after FileCache 1003 read it), then FilePort 1002 may send an update.

FilePort 1002 may send the update in one or more suitable ways. In one embodiment, for example, FilePort 1002 may send only the new hash, without the data, hoping that FileCache 1003 has the new block cached from some other file. If the FileCache 1003 does not have it cached, it may notify FilePort 1002 and may ask it to send the full data or a Delta portion. In another embodiment, FilePort 1002 may send the new block as a whole. FileCache 1003 might already have the block cached, and thus may ignore the data received. In yet another embodiment, FilePort 1002 may send a Delta between the new block and the old block (or any other suitable block).

In some embodiments, the decision on which action to take may be based, for example, on one or more conditions or criteria In some embodiments, if FileCache 1003 does not have the original block, no Delta will be sent. In some embodiments, if FileCache 1003 recently notified FilePort 1002 that FileCache 1003 has the new block cached, only block hash may be sent. In some embodiments, if the latency is high, only the block data may be sent. In some embodiments, if bandwidth is low, only the block hash may be sent. In some embodiments, if many files hold references to that block, only the block hash may be sent. In some embodiments, when block data is about to be sent, it may be beneficial to try to produce a Delta first, although this may be avoided, for example, if CPU resources are low.

In some embodiments, FilePort 1002 may also use or manage a database, or any other suitable structure to store data and retrieve it (e.g., a relational database, a file system or another data structure), of Deltas between different hashes. This way, a computed Delta may be stored, and if needed again, it may be sent without re-computing it. Storage of blocks, hashes and Deltas may be managed, for example, by LRU cache. In case a block is missing, it may be re-read from EFS 1001; in case that a Delta is missing, it may be re-computed.

In some embodiments, a plurality of write requests for the same file may be supported by system 1000. Some applications (e.g., database applications) may allow multiple users to work on the same file in parallel. Such applications may need to avoid the risk of reading or writing non-valid data, as there may be another user doing a contradicting operation on the same file. Some embodiments may use one or more rules or methods of synchronization to prevent a potential clash between multiple users.

In one embodiment, system 1000 may take no special steps for synchronization, and may rely on the environment (e.g., the Operating System or the software application itself) to ensure that each instance is working on different locations in the file, or to otherwise implement a mechanism to identify a potential conflict and prevent it or overcome it.

In another embodiment, a synchronization method may be used. For example, instances of the application may synchronize based on a pre-defined protocol, e.g., a direct protocol, a third entity (“manager”), or using the filesystem. For example, some applications may use the “create file” as a dice, such that all instances try to create the same file, one instance should succeed and the other instances should fail since the file was already created by the first instance, who “won” the lock.

In yet another embodiment, filesystem locks may be used. An application that works on a portion of a file, may lock that portion for that operation and may release it later. Other instances may need to check for locking, or may be denied interference by the server.

In some embodiments, a rule may be implemented to perform write operations only with regard to data that needs to be written, or data that was actually modified. For example, when writing data to EFS 1001, system 1000 may ensure that the exact data that the user wrote to FileCache 1003 is written to EFS 1001. This may also include the possibility that the user may have written data that is identical to the data that was there before; the fact that the user wrote (or re-wrote) that data may be taken into account. In some embodiments, when the user writes data to FileCache 1003, the FileCache 1003 may record the ranges in which data was written. FileCache 1003 may compute the Delta from the previous version, and may send it over to FilePort 1002, along with the ranges list. FilePort 1002 may rebuild the new file using the Delta and then may write exactly the ranges that were received from FileCache 1003.

In some embodiments, locks may be transferred to EFS 1001. For example, when an application requests to lock a portion of a file, the lock request may be sent all the way to EFS 1001. This may be done synchronously, for example, such that only after EFS 1001 granted the lock, FileCache 1003 may grant the lock. In one embodiment, only after the lock was granted, the application may continue to write data to that portion in the file. Along with the lock request, FileCache 1003 may also send read requests on that portion of the file, or on one or more blocks of that file. Along with the lock grant, FilePort 1002 may send the updated data for that block or blocks. In some embodiments, this may be used in order to maintain semantics, for example, since a read operation that is done after a write operation (from any source) to the file needs to access the latest data of the file.

In some embodiments, unlocks may be transferred to EFS 1001. For example, an unlock request that is sent to FileCache 1003 is also forwarded to EFS 1001. Since the purpose of this request is to release other users that might be waiting to lock this portion of the file, fewer restrictions may apply. In some embodiments, in order to optimize performance, this could be sent in an asynchronous manner. For example, FileCache 1003 may return “success” to the user without forwarding the request to FilePort 1002; upon the next transaction to FilePort 1002, or a certain timeout reached, FileCache 1003 may send the unlock request to FilePort 1002.

Some embodiments may use one or more cache management methods. In some embodiments, a main consideration in cache appliances (e.g., FilePort 1002 and/or FileCache 1003) is that the cache size is significantly smaller than the real repository being accessed. Some embodiments may use, for example, a cache management algorithm which may utilize LRU queue, where new coming data replaces the eldest stored one.

In some embodiments, a branch office might have different uses for a cache appliance (e.g., FilePort 1002 and/or FileCache 1003), and thus different ways to handle the caches may be used. In some embodiments, if the usage pattern is defined, assumptions on the cache can be made. This may allow to further optimize cache usage.

In some embodiments, one or more suitable parameters or rules may be defined (e.g., per share) to allow cache management.

In some embodiments, for example, cache priority may be allocated to files or blocks; a file with a higher priority will be discarded from the cache only after files with lower priority were discarded. Some embodiments may evacuate space proportional to the priorities. For example, if a lower priority value indicates a higher priority level, then the cache may evacuate 3 times more space from priority 3 than from priority 1. Blocks with the same priority will be evicted according to LRU, such that Least Recently Used data will be evicted first. This may prevent cases that files stay in the cache although they are not being used, and may still maintain high priority data within the cache more than low priority data.

In some embodiments, for example, modification frequency may be monitored and/or used. For example, cache validation will only happen after the cache validity time (e.g., one divided by the change-frequency) has passed. In some embodiments, the administrator may define the average change frequency estimated to be most relevant per share or volume. If the files in the volume are known to change once a day, a change frequency of 1/24 hours may be defined. When a file is requested to be read, the cache is valid if the file was refreshed from the server less than its Time-To-Live (TTL). TTL may be equal to, for example, one divided by change-frequency. If the file is requested for write access, then a lock request may be sent (e.g., to EFS 1001), and thus the system 1000 may also utilize it as data validation. This way, a correct definition of a TTL may result in substantially optimal (or near-optimal) number of requests for data from the server (e.g., from EFS 1001).

In some embodiments, for example, a ReadOnly binary flag may be associated with a file or a volume. If the ReadOnly flag is set, then the file or volume data may not be altered or modified. The administrator may define a certain share that no user is allowed to write to. This may apply only to users accessing files through FileCache 1003 and not directly. However, when a user tries to access a file on a volume that is marked as a ReadOnly, he may only browse directories or open files for read. Other operations (e.g., create, move, delete, write, etc.) will result in an “Access Denied” response, originating directly from the FileCache 1003, without going over the WAN. This optimization may speed up file open and access, along with ensuring that files and meta-data stay intact on that share, regardless of permissions.

In some embodiments, for example, “exclusive” flags (e.g., True or False) may be associated with files or block. An exclusive share may be a share that is accessed only through a specific FileCache 1003 (e.g., a specific branch office). The defined FileCache 1003 is the only FileCache 1003 that is allowed to access files in this share. This may allow reaching one or more conclusions, for example, that files in the cache never expire (e.g., that their change frequency is equal to zero), and/or that there is no need to lock files at FilePort 1002 and EFS 1001. Both of these optimizations may highly decrease response times to the user, since, for example, many transactions may include cache validation and file locking. In some embodiments, there is no contradiction between a share being both Exclusive and ReadOnly. The administrator may ensure that files in this share indeed do not change directly on EFS 1001.

In some embodiments, for example, a ReadAll binary flag may be associated with files or shares or volumes. For example, a file having the ReadAll flag set, may not contain sensitive information and thus substantially any user may read its content. All files in a share or a volume with this property may be accessible by substantially any user. After a file was cached in FileCache 1003, any user requesting the same file from the cache will be granted (for read) immediately, and without analyzing the file's Access Control List (ACL). This may save the transaction and/or the security check. In some embodiments, write operations, or other operations that need to go through to EFS 1001, may not be approved by EFS 1001, if the administrator did not grant permissions for the user to do so.

Some embodiments may use a “speculative Delta” calculation process or algorithm. For example, some embodiments may correlate different files that exist or existed at different times in the filesystem. When two files are correlated, if they have similar data, then sending a Delta between them may suffice. For example, if a file named “Letter 2.doc” is written to, the system may identify that this file is similar to another file named “Letter2.doc”, which previously existed in the system; in such case, FileCache 1003 may calculate and send the Delta between “Letter2.doc” and “Letter1.doc”, and may ask the FilePort 1002 to apply the Delta on “Letter1.doc” and use that as the data of the new file “Letter2.doc”.

In some embodiments, the reasons that two files may correlate in terms of similar data may include, for example, applications trying to ensure data integrity in case of a crash, using different files during a file save process; or users who tend to save different versions of files in different names (e.g., “Save As”), and all or multiple versions coexist in the filesystem. By monitoring files deletion, creation and rename, some embodiments may find a heuristic that that may determine that two files correlate; and when such a decision is made, a Delta is calculated between the two files.

In some embodiments, if eventually the two files do not correlate, then the Delta calculation fails, and the system may revert to sending a whole file. If the files do correlate, then the system may send the Delta between the files over link 1017, and the FilePort 1002 may use the Delta, as well as the second file that is stored in the cache as the basis for the Delta. If the receiving entity does not have what it needs in the cache in order to build the new file, it may re-request the data, this time not allowing correlation of files. In some embodiments, the last two examples may be a relatively rare case. In some embodiments, the method of correlating different files may decrease or minimize the amount of data send over the WAN connection.

In some embodiments, speculative file correlation may be done, for example, using one or more rules, conditions or criteria.

In some embodiments, for example, when client computer 1004 requests to delete a file, its data is not dismissed from FilePort 1002 and/or from FileCache 1003, but saved in a special location within cache 1035 and/or cache 1025 for future potential correlation.

In some embodiments, for example, when a file is moved, its original name is saved for future potential correlation.

In some embodiments, for example, when a file is replaced (sometimes referred to as “truncate”), its original name and data are saved aside within cache 1025 and/or cache 1035.

In some embodiments, for example, before data of a Dirty block is sent to FilePort 1002, an algorithm for evaluating correlation is activated; after the files are correlated, FileCache 1003 calculates a Delta between the two correlated blocks. If the Delta is significantly smaller than the Plain file or block, then the Delta is sent along with information about the block it correlates with.

In some embodiments, correlation may take into account one or more measures with different weights in order to consider candidates for correlation. The measures that has the largest weight may be the “winner” of this correlation. In some embodiments, if Delta calculation proves that the files are not correlated, then further correlations may be attempted, e.g., with candidate number two, three and so on in the correlation candidates list. In one embodiment, it may be preferred to ensure that the algorithm finds the right file on the first try most of times rather than rely on trying again.

In some embodiments, an algorithm to decide upon correlation candidates may maintain a limited queue (e.g., having a variable or constant size) of filenames that were last opened on each session. Each file will get a score according to parameters, for example: whether or not the file was more recently read than the others (for example, in a copy operation we usually read one file and write to the other); whether or not the file was more recently written to than the others; whether or not the file was more recently opened than others for the last time; whether or not the file is still open; whether or not the file was more recently closed than others; whether or not the candidate's name is similar to the committed filename (e.g., whether or not its name is contained in the committed filename, as in “Copy of Letter.doc”, and if not, whether there is a common substring starting either at the beginning or at the end of the candidate that is longer than a certain percentage of the shorter filename of the two).

In some embodiments, special treatment may be given to files whose names match pre-defined patterns. For example, if the file being committed has the name ˜WRD####.tmp or <8 hex-digits>, then look for a *.doc file or *.xls file, respectively, that is still open on this session; and among such candidates, prefer the most recently opened or “dirtied” file. In some embodiments, when committing a ˜WRL####.tmp file (or, for example, an Excel equivalent), look for the most recently opened *.doc file. In some embodiments, when committing a file called “Copy of Letter.doc” or “Backup of Letter.wbk”, etc., it may be possible to determine exactly the filename needed for correlation. In some embodiments, if the file is a *.doc, *.xls, *.ppt, etc. file, then files with the same extension may be located, or the extension of the application's template file (e.g., *.dot) may be located, for possible correlation. These exemplary rules may be targeted at a specific use of the system, and are provided as an example. Other rules for correlating files may apply in different cases, to “track” what the user is doing and correlate files.

Some embodiments may allow a global name space. For example, in some embodiments, users of an organization with multiple file servers (e.g., using NFS) in multiple locations may need to know where their data resides. If the data is distributed throughout the organizations, a WAN based solution may be used. For this reason, unique path may be provided for each file in system 1000, reachable from every location in the organization, by the same name, regardless of where it resides.

In some embodiments, each FilePort 1002 may maintain a map of file servers and shares. Each file server and share will have an additional entry by the name Global Path (GP). In some embodiments, there may be substantially no limitations on the GP; it need not be correlated with the file server and share. For instance, one embodiment may map EFS1:share1 to /dir3/share1, and also map EFS2:share3 to /dir3/share1/xx3.

In some embodiments, each FileCache 1003 has a list of FilePorts 1002 it contacts, and each FilePort 1002 publishes its own map of servers, shares and GP's. The FileCache 1003 combines the maps from all FilePorts 1002, generating a single hierarchy of directories.

In some embodiments, each node in the hierarchy is of one of three types: Real, Pseudo and Combined.

In some embodiments, a Real node represents a real share in an EFS1001 filesystem. In the example above, /dir3/share1/xx3 is a Real node.

In some embodiments, a Pseudo node does not have any Real files or directories in it. It is only there because it was mentioned in one of the maps as a “point in the way” in the path. In the example above, /dir3 is a Pseudo node.

In some embodiments, a Combined node has some Pseudo and some Real nodes in it. In our example above, /dir3/share1 is a Combined node.

In some embodiments, system 1000 may prohibit the user from changing Pseudo nodes by returning “Access Denied” response to such attempts.

In some embodiments, another use of this technique is data migration. The real location of the file can be quickly changed by changing the map. Users will continue to work and see the same path as before, but now the file may be at different physical location.

Some embodiments may allow partial or full “disconnected operation”. For a cache based file system, there may be a need to provide methods to access files when the WAN connection is not operational. Some embodiments may provide read-only access to files that exist in the cache.

In some embodiments, a disconnection event between FileCache 1003 and FilePort 1002 may occur when the TCP/IP stack software layer returns an error on the socket; this can be, for example, either a timeout or a different cause. In other embodiments, different rules may apply, according to the user requirements.

In some embodiments, detection of a disconnection event will occur immediately if an error is returned, and checked periodically, e.g., every minute. It can also be manually set. When such an event occurs, FileCache 1003 goes into a “disconnected operation” mode.

In some embodiments, during disconnected operation mode, one or more rules may apply, for example: cache is always valid, regardless of the Time-To-Live; a request to open a file other than for read access, will result in an “Access Denied” response; all requests to change a file, data or meta-data, will be denied; and transactions that were in-transit during a disconnection event will behave as if the disconnection event happened before the transactions started.

In some embodiments, during disconnected operation mode, if the share is in read-all mode, access is always granted, otherwise the op-cache (as described herein) will be checked. If the op-cache exists, it will be used, otherwise, the ACL cache (as described herein) will be checked. If the ACL cache does not exist, access is denied or granted, according to a configurable parameter.

In some embodiments, during disconnected operation mode, user authentication may use the local authentication server (e.g., a native authentication server or one that is running within FileCache 1003 or the authentication server over WAN, if reachable), or a cached challenge-response sequence. New users may not be able to login, unless there is an accessible authentication server.

In some embodiments, during disconnected operation, a test for re-connection will occur, e.g., every 30 seconds. If all conditions for disconnection event are false, a reconnection event occurs.

In some embodiments, there is also a notification to users that the system switched to a disconnected operation mode. This could be realized by either a message to the desktop (for example, using Windows Messaging protocol), or using a special client that is installed at the user's desktop.

Some embodiments may use user level security. For example, some embodiments may include a WAN file system, proxy based, that authenticates users in pass-through mode.

When a client computer 1004 authenticates against FileCache 1003 using a challenge-response mechanism, its request for authentication is passed through FilePort 1002 to EFS 1001, which in turn returns a challenge. The challenge is sent back through FilePort 1002 and FileCache 1003 to client computer 1004. The client computer 1004, believing that the challenge originated from FileCache 1003, provides a response, which is transferred all the way to EFS 1001 in a similar manner. The EFS 1001 believes that the response originated from FilePort 1002, grants the authentication request (e.g., if this was a legitimate request) and creates a session for FilePort 1002, under the original user's privileges. FileCache 1003 also does the same, and creates a CIFS session for the user of client computer 1004.

This way, some embodiments may achieve a legitimate CIFS session that exists both between client computer 1004 and FileCache 1003, and between FilePort 1002 and EFS 1001. These may actually be two different sessions, but they share the same privileges. In this way, substantially every operation that the user does on FileCache 1003 can be reflected exactly on FilePort 1002. All authorization, auditing and quota management is done in the same way on EFS 1001 as if client computer 1004 was connected directly to it.

In some embodiments, FileCache 1003 may or may not be a part of the Windows domain (or active directory).

In some embodiments, CIFS file servers may break a CIFS session with no locked files after a few minutes of inactivity. A client with locked files must send an echo message to the server, signaling that it is still alive. To preserve this mechanism, FilePort 1002 sends echo requests to EFS 1001, as long as FileCache 1003 sends I-am-alive transactions for this session.

In some embodiments, if the session breaks between FilePort 1002 and EFS 1001, upon next request to EFS 1001, the FilePort 1002 notifies FileCache 1003 in the response that the session is not valid anymore. FileCache 1003 in turn breaks the session with client computer 1004, forcing it to re-create it using the challenge-response mechanism. This is done transparently for the user, for example, using Windows Operating System. After re-initiating the session, Windows clients repeat the original request.

In some embodiments, if the session breaks between the client computer 1004 and the FileCache, then FileCache 1003 stops sending I-am-alive transactions to FilePort 1002 on that session. FilePort 1002 will not send echo messages on this session anymore, and EFS 1001 will initiate a session close after the timeout (e.g., between 4 and 15 minutes, configurable for Windows servers).

In some embodiments, for other authentication mechanisms that do not use challenge-response methodologies, other methods may be used. For example, for Kerberos, system 1000 may be configured to work with forwardable tickets, so the tickets can be forwarded from FileCache 1003 to FilePort 1002 to EFS 1001.

Some embodiments may use branch level security. In some embodiments, in addition to working in pass-through mode, there is another mode of operation for a caching system. Some embodiments may have a separate special user per each installed branch. The user will have a superset of credentials that exist in the branch. FileCache 1003, upon connection to FilePort 1002, will identify using this user. FilePort 1002 will validate the user using the authentication server, and will connect to EFS 1001 using that user. All operations done on files will be done on behalf of that user.

In some embodiments, for example, user quota (if being used) is not preserved. Since files are used by a different user, in some embodiments there is no knowledge of the originating user, and his quota changes may not be managed

In some embodiments, for example, file ownership is not preserved. When new files are created, they are owned by the special branch user. In order to avoid accessibility problems, FileCache 1003 adds the original user as “Author” of each file created. In other embodiments, FileCache 1003 may set the owner of the file as the original user, after the file creation, if this is possible.

In some embodiments, for example, branch security may be always preserved. The special branch user privileges define a limit on what a branch user can do with files. If a privileged user goes to the branch, he is still limited by the special branch user's privileges. In some embodiments, even if the branch security is compromised, files that cannot be accessed by the branch user may not be accessed.

In some embodiments, for example, session break may be handled. If a session breaks, all the files are closed and locks released. In case of a sporadic WAN connection, this can happen relatively often. Using branch level security, system 1000 may re-create the session if the connection is re-gained, without intervention of the user of client computer 1004. Moreover, if files were locked by the session, the locks are re-created (e.g., unless the files were changed).

In some embodiments, FileCache 1003 may support quotas. In some embodiments, FilePort 1002 synchronously updates EFS 1001 with write transactions that it receives. Therefore, being pass-trough authenticated, FilePort 1002 supports user's quota. On FileCache 1003 side, however, write requests are not always immediately verified (and for Short Term File Handling (STFH) they are never verified). In order to avoid quota limits violation, FileCache 1003 may self-manage these limits.

In some embodiments, FileCache 1003 handles a list of <user, share> entries; each entry holds an actual quota limits which is updated periodically from FilePort 1002. In addition, the entry is updated during the operations that affect the amount of share free space (namely: write, set file size, and delete).

In some embodiments, in Win32 semantics, the user that is charged for the quota is file's owner and not necessarily the user that performed the actual change. Therefore, in some embodiments, FileCache 1003 uses the file's security descriptor in order to update its quota list.

Some embodiments of the invention may use backup consolidation. For example, some organizations have and will continue to have remote file servers at the branches. Using backup consolidation in accordance with some embodiments of the invention, one can back up the remote file servers in the same manner he backs up his data center.

In some embodiments, installation is done by installing FilePort 1002 at the branch office and FileCache 1003 at the center. FilePort 1002 is configured to give access to the same share that needs to be backed up. FileCache 1003 at the center is configured to connect to all the remote FilePorts 1002. The administrator configures his centric backup software to back up the shares that reside at FileCache 1003. The shares are configured as read-all, non-exclusive, read-only (unless a restore function is also needed through this method). In some embodiments, when the backup software tries to read the files from FileCache 1003, the FileCache 1003 makes sure that the files read are the latest files that exist at the remote branch.

In some embodiments, using the cache and other suitable optimizations, bandwidth usage may be optimized over WAN, and only the data that was actually changed since the last run is transferred over the WAN.

Some embodiments may allow old or previous versions retrieval. In some embodiments, system 1000 may be used in order to retrieve old or previous versions of files that were saved through the system. This allows, for example, the benefits of automatic version management for users, without involving the administrator.

An advantage some of embodiments of the invention over standard backup solutions, or standard snapshot solutions, is that it is event-driven and not time-driven. A regular backup or snapshot solution may be configured to happen every X minutes. If the user happens to need a file that was saved and deleted within less than X minutes, the file will not appear in the backup listing. A solution in accordance with some embodiments of the invention may save every version of the file or document that existed.

In some embodiments, every directory may contain an additional pseudo directory, for example, named as “archive” or using another suitable name. The directory will be added by FilePort 1002. When the user tries to open the “archive” directory, its contents is dynamically built. For example, FilePort 1002 reads the file listing of the same directory “archive” is in, and prepares a list of all the documents that have different versions in its cache. In some embodiments, since FilePort 1002 saves all the Deltas calculated and the time of the calculation, such a list can be relatively easily built from the cache.

For each such file, FilePort 1002 creates a pseudo-directory, by the same name as the file. When the user browses into that directory, the user sees a list of pseudo-files, but their names are dates and times, that represent the dates and times in which the file was saved.

Opening these files (e.g., for read-only) will provide the user with the version as existed at that date and time.

For example, if there is a directory structure with:

\documents\LetterA.doc

and

documents\LetterB.doc

then another item may be seen at that directory, namely:

\documents\archive

By entering the latter directory, two additional directories may be seen:

\documents\archive\LetterA.doc\

and

\documents\archive\LetterB .doc\

Inside the latter, for example, the following two files may be seen:

Date_{—}2002-07-27_Time_{—}17-20.doc

and

Date_{—}2002-08_{—}14_Time_{—}05-20.doc

The modification times of these files may, for example, correspond to the same as the file names, to ease sorting.

In some embodiments, when the user tries to open a file, FilePort 1002 sends only what FileCache 1003 needs to build the file up to the version number requested. In order to do so, it uses the cached version number of FileCache 1003 in preparing an appropriate Delta in order to get to the requested version. In one embodiment, the Delta may reduce the version number that FileCache 1003 has in cache. FileCache 1003 may use the cache it has for the original file.

Some embodiments may use a virtual remote client. For example, some embodiments of the invention may be used by installing a module on a mobile computing platform, e.g., a laptop computer, a notebook computer, or a Personal Digital Assistant (PDA) device. The user can use the mobile computing platform in the office, indoors, at home or outdoors.

Some embodiment may allow calculation of Delta (“Diff”) between blocks, e.g., between portions of files. Some embodiments may substantially avoid comparing files, and instead may compare appropriate file blocks.

In some embodiments, there may be, for example, two functions in the scope of Delta calculation: a first function getting two blocks, namely, Block1 and Block2, and returning a Delta which may be equal to (Block2−Block1); and a second function getting Block1 and Delta, and returning Block2.

In one embodiment, a binary Delta may be of O(n2) complexity, yet in some alternate embodiments other processes may be used to achieve O(n) complexity.

In some embodiments, the Delta may be a stream of tokens, wherein each token may be of one of two types, namely, a Reference Token and an Explicit String Token.

A Reference Token may include, for example, an index into Block1, and the length of the referenced string. When patching the Delta on Block1 in order to reconstruct Block2, the referenced string may be copied from Block1.

An Explicit String Token may include, for example, a string that appears in Block2, and which is not found in Block1.

In some embodiments, the Delta algorithm may use a hash table, for example, an array of about 64 KiloBytes entries, each entry contains an index into Block1, an the entry's index is a hash of the 8-Byte-word (“8B word”) at that index in Block1.

In some embodiments, the Delta algorithm may use buffers, for example, a token buffer and an Explicit String (ES) buffer. These memory buffers may be used to store token and explicit string data, before they are compressed to create the final Delta.

In some embodiments, a three-phase Delta algorithm may be used.

In the first phase, a hash table of entries within Block1 may be created, to allow access to strings in Block1 directly (e.g., in O(1) complexity) without searching for them in Block1 (which would be O(n) complexity). The chances of finding the searched string, assuming it exists, are related to characteristics of the hash table.

In one embodiment, the hash can be of 8B words of Block1. This may be the minimal size in which there is enough differentiation between blocks. In some embodiments, 4-Byte-words are not sufficient, for example, because they represent only two Unicode characters. Larger words may be hashed, although this may consume more CPU resources.

In one embodiment, benchmarks show that the hashing takes a considerable percent of the total Delta time. In order to reduce the hash time, it is possible to hash only 1/19 of the overlapping 8B words in Block1. For example, in a 1 MegaByte Block1, there may be (1024-7) overlapping 8B-words. In one embodiment, only about 53 of these 8B words may be hashed. The index distance between two consecutive hashed words may be 19, or other suitable distance in various implementations.

In one embodiment, a “backwards comparing” technique (described herein in the second phase) may be used, e.g., to overcome the effect of hash misses that result of the partial hashing. Some embodiments may hash blocks in all offset into the 8B word, and not hash blocks on word boundaries, since the second phase may advance by 4-Byte-words (“4B words”) at a time, while still detecting blocks that have their index shifted by one byte between Block1 and Block2.

In some embodiments, Block1 is traversed backwards, so that the easiest (e.g., smallest index) appearance of an 8B-word in the block may be the one that is in the hash table, and for performance reasons, this may avoid checking that the hash entry is “empty”. One reason to prefer the earliest appearance of a word to appear in the hash table, is to detect “Runs”, wherein a “Run” is a long string of identical bytes, typically “0” values or “255” values. This way, one of first words of the Run will be cached, and there is a good chance to detect the whole Run in the second phase.

One hash function which may be used is (mod FFF1), or other suitable hash functions. It is noted that FFF1 is a prime number. Z-FFF1 is cyclic group, ensuring that the hash is evenly distributed, e.g., without a-priori knowledge of the data distribution in Block1. In some embodiments, the hash function may be coded in Assembly Language or Machine Code.

In some embodiments, the hash table is not initialized, and at the end of the hashing function, entries contain either an index into Block1 (e.g., a valid entry) or non-valid data.

The second phase may determine whether an entry is valid or non-valid.

In the second phase, Block2 is traversed from beginning to end, to find strings that are identical to strings found in Block1, albeit not necessarily at the same index. For each such string found, this phase outputs (e.g., to the Diff) a Reference Token that indicates the index and length of that string in Block1. If no such string is found, this phase may output the Block2 word as an Explicit String Token. Several consecutive Block2 words may be grouped into an Explicit String Token.

Then, this phase loops through Block2, and for the current 8B-word (called datum), finds the longest string in Block1 at the index hash_table(HASH(datum)) that is identical. It may be the case that this entry of the hash table contains non-valid data, or that it contains an index into Block1 that contains a word other than datum (e.g., because two different datum items may hash into the same hash table slot), in which case an Explicit String may be output (e.g., to the ES buffer).

In some embodiments, up to 128 consecutive Explicit String 4B-words are described by one ES Token, which is output to the token buffer.

In some embodiments, if an identical string of some length is found in Block1, then this phase may output a Reference Token to the token buffer. In some embodiments, a backwards check may be performed, e.g., to determine if the string found actually starts earlier than the recent finding, in which case pervious tokens written to the token buffer may be deleted, and potentially previous Explicit Strings written to the ES buffer may be deleted, and replaced by a large Reference Token.

In some embodiments, only two kinds of tokens may result, and there may not be different kinds of Reference Tokens with different lengths. The third phase compression may compress the token buffer; therefore, in one embodiment, bytes within the reference token may be pre-organized in the second phase, e.g., to help an entropy compression algorithm to compress better.

The third phase may compress the token buffer and the ES buffer, and may add a header to create the final Delta or Diff. Compression may be done using any suitable compression algorithm, for example, zlib (Lempel-Ziv algorithm) using maximum speed (e.g., 9).

In some embodiments, the token buffer and the ES buffer may be compressed separately, e.g., to achieve a total compressed buffer size which may be about 10 to 15 percent smaller, because of the different characteristics of these two buffers.

In some embodiments, the Delta algorithm may be supplied with a list of ranges in the file that were changed. The Delta algorithm may then run only on those ranges, and not spend time or resources on areas in the file that were not changed.

In some embodiments, dividing the file into blocks may simplify a Delta procedure, e.g., if some data was replaced in the file, then only changed blocks will be subject to the Delta procedure. If data was inserted or removed in block K, in a file having N blocks, then all the blocks from K and further will have a Delta. In order to overcome this, the Delta may be provided with different dictionaries, e.g., [K-N] or the entire file.

In some embodiments, read-ahead and write-back predictions may be used. System 1000 may utilize a set of optimizations that may be based on usage patterns, e.g., of common Windows and/or Office applications.

For example, when Windows Explorer opens a directory, it fetches all the files in it. It may be known that Windows Explorer needs to display a file-associated data (e.g., preview, icon, etc.) and which areas are read in which kinds of files. It may be known that some applications (e.g., Word, PowerPoint, some MP3 players) may allow users to start working before the entire file has been read. In a large or non-cached directory or file, some embodiments can improve user experience by supporting predictive transport of a data needed.

In some embodiments, FileCache 1003 may attach additional requests or instructions to a transaction, based on its prediction decisions. For example, FileCache 1003 may request some blocks and file's metadata along with an “open” transaction, or parent directory's metadata and free disk space during a “delete” transaction. FileCache 1003 may get an actual status of a neighbor blocks during block-related transactions, or get another file's information when an Explorer-like browsing pattern is used.

In some embodiments, FileCache 1003 may be aware of a CIFS timeout possibility (as described above) and thus may avoid collection of too much data that it will need to commit during the close or flush requests. When this data overpasses the certain limit (e.g., calculated on-demand due to current network and file conditions, pre configured or dynamic), the data is committed on the FilePort 1002.

In some embodiments, some Windows clients tend to ignore the “close” results; yet this may not interfere in some cases with file-system and application semantics. In some embodiments, FileCache 1003 may not send some blocks on “close” requests and may attach them with next transactions. When FileCache 1003 gets an “open” request and it still has such a “close” pending from the previous request, it may extinguish both. Taking into account that some Windows applications use to open and close the same file a numerous number of times in a sequence, this approach of some embodiments of the invention may be efficient and useful.

Some embodiments may handle Short-Term Files (STFs). Some applications often hold their intermediate data in temporary STFs. These files are accessed rapidly and are heavily used, but they are normally deleted when the application completes its work; therefore, in some embodiments, STFs may be held locally on FileCache 1003. When the temporary file is created via FileCache 1003, the FileCache 1003 may decide to create the file as STF. In some embodiments, this decision may be based on the file's name and/or extension.

In some embodiments that handle STFs, a parent directory may be managed, as directories that FilePort 1002 sends to FileCache 1003 may not include the STFs. Therefore, for each directory that contains STFs, the FileCache 1003 manages separate “faked” directory and merges it with the real directory during directory read. When looking up the file, FileCache 1003 searches in the real directory first and then in the STFs directory.

In some embodiments, certain applications tend to rename STFs to the regular files; for example, Microsoft Word may save a document by opening a “Letter1.doc” file, copying it to a “Letter1.tmp” file, deleting the “Letter1.doc” file, and renaming “Letter1.tmp” to “Letter1.doc”. In such case, data that was stored locally may be transferred to the FilePort 1002 at once. If the file is large and causes a CIFS timeout, the application may fail; and, in some cases, write-back may not be applied here. Instead, in some embodiments, system 1000 may choose not to define such temporary file as STF, and a file that has been created as STF may remain in that status.

Some embodiments may handle some NFS aspects. In some embodiments, a file server (e.g., NFS server) may need to supply unique handles for its files. For every file accessed by a client, the client receives from the server a unique ID. The client then uses that ID to access the file. Some NFS servers do not require an open( ) transaction before read or write operations, and thus the unique ID may be used. This means that a NFS file server needs to be able to find the file data upon a request that contains only its ID. Some NFS servers use the real file system for this, e.g., they provide the actual block number (inode) to the client. However, in some embodiments, a caching file system that supports NFS may not do the same, since it is caching and does not store the files physically.

In one embodiment, a database may be used to relate all the files and their unique ID. This approach may result in a relatively slower performance, may make it difficult to identify moved files, and may make it difficult to determine which entries where evacuated from the ID list.

In an alternate embodiment, the same unique ID that comes from the server may be used; although this may cause a problem in case different servers might use the same ID (e.g., since the ID may be unique per server and not per network).

Some alternate embodiments may use a shadow directory. Since there is a unique ID for every server (server-ID) and a unique ID per file in every server (file-ID), a special file may be created and named “<server-ID>-<file-ID>”. The underlying file system gives a unique ID per every file (mode) since it is a regular storage system. Some embodiments may use the unique ID of the shadow file, that gives a unique, consistent, persistent ID for every file that is accessible through the cache. Trusting the underlying file system (e.g., ext2, ext3, jfs, xfs, reiserfs, or reiserfs4) may be an efficient and optimized solution.

Some embodiments may use security descriptors hash. In some embodiments, in addition to caching files and files structure (meta-data), security descriptors (SDs) may be cached. An SD may contain information about who is entitled to do what operations to a certain file.

In some embodiments, caching SDs may allow to analyze the SD and decide if a certain user can do a certain operation on a file; may allow to send the SD to the client when it issues a GetFileSecurity( ) request; and may allow to provide information about the file's owner, e.g., in order to support quota.

In some cases, even for large deployments with many files, there may be very few different SDs. In order to save space and transactions, the SDs may be saved in a special directory, under a file by a name identical to the SD hash. The hash can be computed by any suitable hash algorithm, e.g., MD5 hashing algorithm.

In some embodiments, the file structure may include a field that contains the SD hash. When a new file is read, its SD hash is computed by FilePort 1002 and sent back to FileCache. If the FileCache 1003 already has this SD in its cache, it doe not need FilePort 1002 to send it over. Since the ratio between different SDs and different files may be close to zero, many transactions and bandwidth may be saved by caching each different SD only once.

Some embodiments may not maintain reference count of any kind on the SDs, as they may be saved as part of the LRU cache which ensures that unused SDs get evicted from is the cache eventually.

Some embodiments may use a directory lookup cache. In some embodiments, a client issues many requests for file lookups. This may actually be the most used request from a client. Many applications search for files to make sure they do not exist. In some embodiments, optimizations may be used for performance reasons, e.g., using “positive caching” and “negative caching”.

In some embodiments, “positive caching” includes saving, for every successful request, the fact that the specific file was found in the specific directory, and the result of the search (e.g., the file unique ID). When another request to search for the same file arrives, this cache (“directory entry cache”) may be searched to check if this file was already found, and if so, the previous result is returned.

In some embodiments, “negative caching” includes saving, for every failed lookup request, the fact that a certain file was not found in a certain directory. When subsequent request to lookup for the same file arrives, that cache may be searched, and if it is found, the result (e.g., that the file does not exist) may be returned. Suitable steps may be taken in invalidating this cache. For example, when a directory is changed (e.g., as known according to its version number), all the positive and negative caching for this directory become invalid. One embodiment may go over all the caching for that directory and update it, or in an alternate embodiment the cache may be deleted.

Some embodiments may use NFS open/close optimizations. NFS version 2 does not support open/close transactions. Since Unix or Windows file-system may requires an open transaction before read/write requests, and a close transaction when the data is flushed, some NFS clients tend to open the file before every read/write request, and close it immediately afterwards. When the storage is local to the server, this may go unnoticed, but on a WAN file system this may be handled in a suitable way.

In some embodiments, when using the system to serve NFS requests, close requests (and subsequent open requests) may be ignored, and a different thread may be used to perform them. Since a NFS client may choose to execute many subsequent read requests, this may save many adjacent close-open transactions.

In some embodiments, when a close request that originates from a NFS server arrives, the local (e.g., FileCache 1003) file handle is closed, and nothing is sent to the server. If, after a few seconds (e.g., 5 seconds) an open request arrives, having the same attributes as the previous open, the file may be re-opened and nothing may be notified to the FilePort 1002. In some embodiments, if no Open request arrives within those 5 seconds, a Close request may be sent to the server.

In some embodiments, this may improve performance, for example, since at least two transactions are saved for every additional read/write subsequent request from the client. On the other hand, in some embodiments, no semantics problems arise, and there are no requirements on the server regarding when to save the data to persistent storage. In one embodiment, an exception may be a flush( ) request, which the system may honor synchronously.

Some embodiments may use dynamic compression and Delta filters. In some embodiments, each file that is sent to the server goes through two compression functions: one that tries to compare it to another file and send only the Delta between them, and another that compresses the file using a suitable compression algorithm. In some embodiments, both of the methods may be applied, regardless of which one has failed; wherein “failure” means that the total save in file size was not worth the time and resources (e.g., CPU cycles) invested.

In one embodiment, in which there is no easy way to anticipate the outcome of a compression or a Delta activation, it may be beneficial to try to save unnecessary activations of the Delta algorithm.

Therefore, in some embodiments, a dynamic filters system may be used. For example, when the system runs an algorithm on a file, it saves the number of compressed (or Delta) bytes divided by the original file size, and the file extension (e.g., the string after the last period character in the file name). During its operation, the system collects information (e.g., average compression ratio) about the compressibility of certain types of files.

In some embodiments, if files have compressibility lower than a certain threshold (e.g., 70 percent for compression or 20 percent for Delta production), the appropriate algorithm will not be used the next time such a file is sent.

One embodiment may also set a static set of rules that will work well, without using a dynamic system. For example, such a rule may be that files having a certain extension (e.g., extension of ZIP, MPG, MP3, OGG, etc.) need not be compressed.

In some embodiments, in order to change decisions, the system may slowly increase the compression ratio for each type of file it chooses not to compress, until it passes the threshold ratio again, and another test may be performed. The results are saved on a persistent cache, so the system is optimized after a few days of use to the types of files actually used.

Some embodiments may use mirroring. A cache based file system may have means to pre-populate the cache, to give higher cache-hit ratio and better performance for the users.

Some embodiments may populate the cache by running a program that scans the relevant directory tree, and reads all the relevant files there. Traversing the directory tree will result in the cache being populated at the end of the traversal. If this program runs at night times, users may start working in the morning with a “fresh” cache. However, with this approach, every file is read separately and using a special transaction; thus, for N files in the system, around K*N transactions may be needed, wherein K is a small single-digit number depending on the implementation.

In some embodiments, another approach may be used, for example, a mirroring mechanism. This includes a special transaction that is capable of synchronizing the contents of many files. When FileCache 1003 updates its cache, it runs the mirror transaction that includes information about all the files that need refresh, along with their cached version numbers. FilePort 1002 responds with a list of updates, e.g., responses such as “No update, you have the most recent version” or “You have an old version, here is a Delta to patch for the latest version”. The amount of files to be sent per transaction can be configured; one embodiment may update 100 files each transaction.

In some embodiments, FileCache 1003 may follow closely upon directory updates; if files were added to the directory, they need to be added to the next round of mirroring.

In some embodiments, further optimization may find out, according to the directory information, which files did not change at all, and therefore do not need an update.

In some embodiments, another way to implement such a mechanism is to aggregate a set of requests to one transaction. There will be many Read (or Open) subsequent requests that will be sent in one transaction, and FilePort 1002 will respond to all the requests in one response transaction.

Some embodiments may use block-based LRU caching. FileCache 1003 and FilePort 1002 may share a mechanism to cache blocks of files, while maintaining performance requirements. In some embodiments, blocks are stored on disk, e.g., each block in a separate physical file, named by the key that defines that block. There may be separate directories for each type of the blocks, for example, Plain, Dirty, Delta, etc. Directories may have various attributes, such as LRU, “to-be-deleted-on-reboot”, “permanent”, etc., and may be unified into partitions.

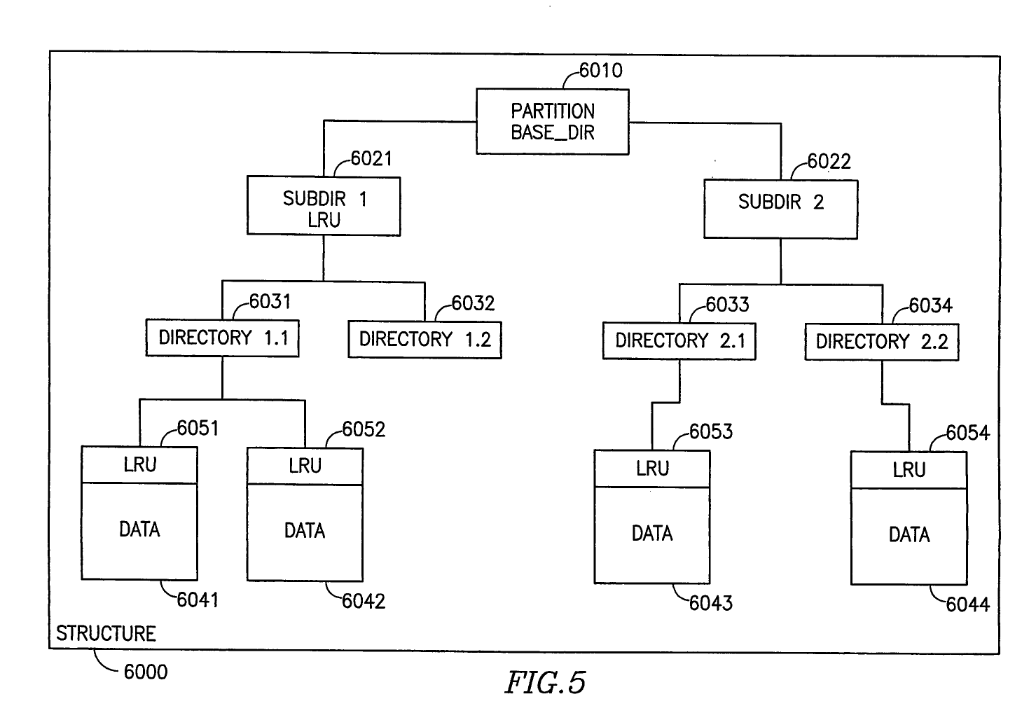

In some embodiments, directories may have structure similar to an exemplary directory structure 6000 shown in FIG. 5. Structure 6000 may include, for example, a partition's base directory 6010, under which a plurality of sub-directories may exist, for example, sub-directories 6021 and 6022. Under a sub-directory, one or more directories may exist, for example, directories 6031, 6032, 6033 and 6034. Through a director, one or more data items may be reached or accessed, for example, data items 6041, 6042, 6043 and 6044. In some embodiments, one or more data items may be associates with a LRU cache or a LRU property, for example, LRUs 6051, 6052, 6053 and 6054.

In some embodiments, in order to ensure dispersion of files within subdirectories (for example, as large amount of files in the same directory may slows performance), files are situated within the tree of subdirectories (e.g., Directory 1.1 in FIG. 5). All files reside under the partition's base directory (“base_dir”), in their corresponding sub-directory (“subdir”). Under that subdir, the path construction may be as follows: given key is broken to 2-character strings (the last string may be shorter), and a slash (“/”) character is inserted in between, so that these 2-byte strings (except the last one) are directory names.

Therefore, the key is an alpha-numeric string.

In some embodiments, to achieve flexibility, the cache subsystem is agnostic to the data it stores, and enables access to the file from the point where the LRU section ends, so that if LRU gets X bytes, each read/write request will be performed with shift equal to X. Since the system shares disk resources for all kinds of cache, and, therefore, uses a single storage instance, all cache types share the same key between them.

In some embodiments, the LRU lists themselves are maintained in the files rather than in memory, and the storage module maintains a recovery file during each LRU operation.

This recovery file is read at initialization time and acted upon, to ensure that if an LRU operation fails and causes a “crash”, then after reboot the broken LRU may be fixed and return to a consistent state, for example, either to the state before the operation that failed, or to the state after that operation.

In some embodiments, files are discarded not only according to their LRU status, but also according to their share priority. For example, priority meta-nodes are kept in the cache LRU queue, one meta-node per priority, and can be marked as M1, . . . Mn (for example, n may be equal to 5). Pointers to these meta-nodes are maintained at all times. When the cache is empty, the queue may have a structure similar to the following:

Head→M1→M2→ . . . →Mn→Tail

In some embodiments, a cache Insert operation may include, for example, calculating entry's priority according to its share priority, type, state and data size; and if j is its priority, inserting it right after (e.g., to the right of) Mj.

In some embodiments, a cache Touch operation may include, for example, any use of the file that makes it the most recently used one; if the file's share priority is j, then it may be moved to be right after (e.g., to the right of) Mj.

In some embodiments, a cache Delete operation may include, for example, deleting the file out of the queue.

In some embodiments, a cache Discard operation (e.g., to free space) may include, for example, starting to discard from the Tail side, and discarding as many files as needed, until their accumulated sizes pass the required space to be cleared. For each file discarded, if its priority is k, the first k regular nodes from the left of Mj are moved to its right, wherein k may be a constant number. “Pinned” files may be situated between the Head and M1. The LRU never removes the files that are situated left to M1.

In some embodiments, the Discard operation makes the higher priority files drift down the queue, passing the meta-nodes of lower priorities. Thus, with time, the files along the queue will be of mixed priorities. The higher priority files may get a better “head start” is when they are inserted or touched, so that they have a longer way to drift with LRU before they get discarded.

In one embodiment, consideration may be given to the starting period, when the cache has just filled up for the first time, before sufficient Discard operations have been done.

During this period of time, the queue may still be substantially sorted by priorities, and the first files to be discarded will be the lower priority files. In some embodiments, to achieve quick performance, k may be set to have a value higher than one, for example, ten.

In some embodiments, the architecture may be based on file system protocol tunneling. FileCache 1003 is placed in each remote office requiring access to files residing at another site (e.g., the enterprise data center). FileCache 1003 appears to the client computers 1004 at the remote site as a regular file server residing on that network.

FileCache 1003 receives requests from the remote site clients as a regular file server would do, but rather than serving these requests from its local hard disk, it tunnels them over the WAN using the DSFS protocol, to FilePort 1002 that resides at the data center. The FilePort 1002, receiving the requests tunneled from FileCache 1003, acts as a regular client when accessing the data center's file server in order to fulfill the original client's request.

In some embodiments, the architecture may use algorithmic optimizations, on FileCache 1003 and/or FilePort 1002, in order to reduce the amount of data sent over the system 1000 and/or the number of round-trips needed between FileCache 1003 and FilePort 1002 to service a client's request.

In some embodiments, when a file is requested to be read, or written onto, it undergoes several layers of optimizations and modules of the system. The purpose of those layers is to serve as much as possible from the local cache, without hurting semantics, and if the server needs to be contacted, it may be in an efficient way.

In some embodiments, some files are known to be less important to the administrator, or they appear for a short time and then disappear. In some embodiments, the system may choose to leave those files at the remote site, and perform all the operations locally there, without sending them back to the EFS 1001.

In some embodiments, each part of file that is being read by the client is saved locally at the remote site, in case it will be needed again. If the second request for the same data was within a short period of time from the first, it is served directly from the cache. If some time has passed, it is verified with EFS 1001 that this is the correct version, and then it is served from the cache. In some embodiments, a full set of data is sent across the network only once, and after that only Deltas are sent.

In some embodiments, each file or block is assigned a version number. Files may be cached at various places along the route (e.g., on the client computer 1004, on FileCache 1003, on FilePort 1002, or in the memory of EFS 1001). The DSFS system contains cache-coherency mechanisms that keep track of what version of the file is cached in each location, and uses this information to minimize traffic across system 1000. For example, if the up-to-date version of a file requested by a client computer 1004 is cached on the FileCache 1003, there is no need for FileCache 1003 to request that file from FilePort 1002. Similarly, if an older version of a file requested by a client computer 1004 is cached on FileCache 1003, then only the Delta needs to be fetched from FilePort 1002 to FileCache 1003.

In some embodiments, as the FileCache 1003 acts as if it were a file server on the remote office's local network, it may be aware of every file-system Input/Output request coming from applications. FileCache 1003 may be able to detect request patterns and, based on these patterns, perform optimizations that further reduce network traffic between FileCache 1003 and FilePort 1002.

In some embodiments, an independent algorithm for computing a binary Delta on two files may be deployed. The algorithm may detect changes that were made to the file, even if an unknown binary format is used. Changes may be of several forms, such as insertions, deletions, block moving, etc.

In some embodiments, data sent across system 1000 may undergo compression in order to further reduce the amount of network traffic.

In some embodiments, since branches may access a pre-defined set of data, it can be pre-fetched periodically to the cache (e.g., to FileCache 1003), to make sure data is fresh, and no additional transactions may be needed during the day. This may help increase the cache hit rate to close to 99 percent, and may increase and improve user experience

In some embodiments, different files may call for different access patterns. In some embodiments, the system may learn the way applications use certain files, and try to fetch the relevant records of the file even before the user requests them, if they are not there already.

In some embodiments, a write operation may be delayed until the file is closed, or until a significant amount of data is waiting to be committed to the file. This enables to reduce the number of transactions to the file server, and may save bandwidth. It may not affect file system semantics, for example, since CIFS/NFS does not mandate synchronous write to disk due to a write operation.

In some embodiments, when a user selects an application's “Save” button or function, that application will receive a positive (“OK”) response and may continue its operations, only when the data is safely saved on the data center file server (e.g., EFS 1001). The FileCache 1003 does not deploy “store and forward” logic, in order to achieve reliable storage. If something goes wrong along the way (for example, the user is out of disk quota or the EFS 1001 is not operational), the user will receive a notification of this event, and be given the opportunity to save his data elsewhere.

In some embodiments, the system may achieve fast and reliable storage process by reducing the amount of data that needs to be sent over the system 1000 in order to complete a successful “save” operation. This is achieved by a combination of compression techniques, differential transfer (sending only the Delta, for example, the bytes that changed), and application-level optimizations.

In some embodiments, DSFS, may be a synchronous protocol and may enable file-sharing semantics with full distributed locking across the WAN. For example, an application may allow the first user opening a document to be granted full read-write access to that document, and would lock the document for the period it is open. Subsequent users concurrently attempting to open that document would be granted read-only access. This LAN behavior is supported by DSFS over the WAN.

In some embodiments, DSFS may fully support native Operating System security mechanisms. For example, in Windows (e.g., CIFS/SMB) environment, fill access control (e.g., ACL) permissions may be enforced and native authentication is supported, for example, for Windows NT version 4 (Domain Controller) and for Windows 2000 (Active Directory). For network security, DSFS deploys internal measures, such as session-key based message digital signing. In addition, DSFS supports, and may rely on, a network security mechanism already installed on the system 1000 such as Firewalls and Virtual Private Networks (VPNs). The DSFS may operate over TCP/IP port 80, thus there is no need to open an additional port on the Firewall. All user sessions may be pass-through all the way, such that EFS 1001 believes that the real user is accessing it directly, instead of though FilePort 1002 and/or FileCache 1003. This may allow other benefits, for example, auditing, quota management, and owner preservation.

In some embodiments, DSFS supports the Unicode standard and is designed to allow a single installation of a DSFS system to work across languages and time zones.

In some embodiments, DSFS may be used with various “document processing” applications. A description of such an application is: applications that have a concept of a “file” or “document” which the user works on, and then saves. Common applications of this type include Microsoft Office applications, graphic design applications, software and hardware engineering applications, or the like.

In some embodiments, the DSFS system can be managed as one or more objects using a central management station. It enables the administrator to deploy defined policies on groups of appliances, and monitor the group altogether.

In some embodiments, the user that works with the DSFS system may not see it as a different external system. FileCache 1003 appears on the local network as if it was the central server, and may even have the same name, such that from the user's point of view, the user is accessing the central file server as if it were on his LAN.

In some embodiments, FileCache 1003 and/or FilePort 1002 can be installed in “high availability” mode. The DSFS software supports it, and the hardware may deploy a No-Single-Point-of-Failure (NSPF) implementation.

Some embodiments of the invention provide a WAN file system that enables true file storage consolidation. This may be achieved by the complete replacement of local file servers with FileCache 1003 appliances. By centralizing the storage, the organization may achieve reduction of costs, an ability to maintain and backup data centrally, and greatly enhanced data security. Some embodiments may include one or more of the following features: near LAN performance, synchronous operation, full file system semantics support, reliable data transport, and environment-based system management.

In some embodiments, the DSFS file system may be synchronous, such that client requests are completed only upon their completion on the central file server. One embodiment includes a transport system and never stores the user's critical data. This architecture enables full support for file sharing semantics. Since the system is synchronous, it requires high responsiveness, which in turn requires a set of optimizations on transfer of files, both data and meta-data.

In some embodiments, to provide file-size independent performance, the smallest independent caching unit may be a block (e.g., a portion of a file) and not a file. In some embodiments, block-based caching may include and/or use block handling such as block-based versioning, block-based Delta calculation, block-based compression, and block-based management. In one embodiment, since cache sometimes cannot be trusted, the various cases of blocks that were deleted from the cache may be handled transparently.

In some embodiments, to achieve high performance over the WAN, a set of optimizations for data and meta-data transfer may be used. Optimizations include, for example: Save-As identification (ability to relate different files by their name/context/work pattern); Speculative resemblance (ability to relate files that are different objects but contain similar or identical data); Predictive read (expect blocks that are about to be read by the user/application and read them in advance, using analysis of application and user behavior); Compression; Delta determination (fast and effective ability to calculate a binary difference between two files or blocks); Versioning (each block snapshot is given a unique Vnum, and only Deltas between versions are transferred on the network, both ways); Content-based caching (blocks that belong to different files are stored only one time in the cache).

In some embodiments, different files that belong to different users may share the same data. Some embodiments may use this knowledge to save storage for caching, and/or to improve performance by substantially not fetching again a block that was already fetched once. This feature may be fully transparent to the users, who may believe that different files contain different information. A decision algorithm is used to determine when a block can be written to and when a copy should be created.

In some embodiments, the system may include an Application Programming Interface (API) for each individual device on the network, a Web interface for each individual device on the network, and a central management station to enable the management of groups of devices. Central management is implemented by applying certain policies (for example, cache configuration, security, pre-fetching definitions, etc.) on a predefined group of appliances. Policies may be applied to all appliances at once and errors reported in a clear way. If an appliance has a different configuration from the group, it may be noted clearly in the interface. Queries on the configuration of a group may be handled in the same way. Information may be collected and aggregated in a human readable format. Resources may be managed across components to ensure high service level to the user.

In some embodiments, a set of options may be provided to configure the behavior of the system. An administrator may define per-share parameters, for example: branch exclusiveness (only one branch may change the files and there is no need to lock on the center, to check cache validity, etc.); read-only (files can never be written to, which can help optimization and allow some applications to open files for write although they do not intend to write to them); read-all (no security checks and no need to read ACL from the server or to parse them along the way); caching priorities (some files may be more important than others, and in some cases one might want to make sure that they stay longer in the cache); change-frequency (some shares change more frequently than others, which can be used to tune the amount of transactions used for cache validity verification).

In some embodiments, the system may use high availability functionality, which means that two or more appliances may back-up each other and cover for each other in case of failure. The implementation may be active-active, such that the stand-by machines are not idle but used to serve user requests. In some embodiments, issues such as management of the cluster as one machine, installation, upgrades, virtual IP addresses, leader election, and others, may be handled by the system.

In some embodiments, the system may be implemented as an engine that provides the basic functionality with a superimposed static rule set. The rules can be changed by an engineer or administrator.

In some embodiments, the latest written data should always be read, so that the cache is used smartly and file or block versioning is sufficiently sophisticated not to corrupt the data while maintaining high performance.

Some embodiments may use consolidation of Novell shares over the WAN by pass-through authentication. Novell 5.1 or later has an add-on to support CIFS, but it does not support GetFileSecurity CIFS transactions, therefore there is no security information about the file. To overcome this, in some embodiments, all operations are sent pass-through to the EFS 1001, and the system may learn, in time, what were the results of each security request (“operation caching”). When the user requests an operation on a file he requested before, he receives the same response if it is within a valid time.

In some embodiments, aggregated file system instructions with internal dependencies may be used. To reduce the amount of transactions over the WAN, intelligence for aggregating file system operations may be used.

In some embodiments, “predictive aggregation” is used when the system expects a specific transaction and “holds” the previous transaction (if possible as a result of synchronous operation semantics) to determine whether there is another transaction on the way. An example is deleting a directory, which translates into a GetFileAttributes and DeleteFile for each file in the directory tree.

In some embodiments, “piggybacking aggregation” is performed when an operation forces a transaction and is added to several other transactions that were on hold (e.g., write Dirty blocks), or when it is expected that several transactions will be required at a later stage (e.g., get directory attributes, read ahead transactions).

In some embodiments, when a directory is changed (or file metadata changes), the DSFS system may send only the records that represent the files that were changed. In some embodiments, since there may be no hooks to identify what was really changed, an algorithm may be used to compare a cached directory with the real one. The result may be file IDs that were changed. Such a change could be a delete, rename, write, change attribute, create, etc. In some embodiments, only this information is sent across system 1000, and is then reassembled at the other end.

Some embodiments may include a method to synchronize the cache, usually at night. Instead of automatically fetching each file and checking versioning information, a set of block and block versions is sent to the central FilePort 1002, which then responds with fresh information about the files (metadata and data). This may be optimized to network conditions and load.

Some embodiments may include file system operations pattern recognition. In some cases, a WAN file system may identify similar sets of data Some modern applications do not open a file and write to it, but rather move it to different folders under different names, write to a different file, etc. Users also maintain different versions of files, usually by renaming them or performing “Save As”. The difference between the data in these files is often minor. In some embodiments, behavior pattern matching algorithms may be used to identify these similarities and utilize them when sending data over the system 1000.

In some embodiments, enhanced automatic resource balancing per device may be used. In some embodiments, since the system uses local resources to save on remote resources, there are some cases (e.g., extensive load, high-bandwidth networks, low latency, etc.) in which a decision can be made of whether to run the algorithms and try to save bandwidth, or send the data over the network “as is”. The algorithm may consider the dynamic aspects of the system: current load, current network status (latency, packets drop, and congestion), file and storage types, and user priority.

Some embodiments may implement a pair-wise, active-active high availability solution. A FilePort 1002 (or FileCache 1003) may be installed as a pair of machines, that will run two instances of the FilePort 1002 software. In case of a failure, the surviving machine will take over the failing instance. Instance migration will be possible using suitable techniques, for example, shared storage (SCSI or SAN), serial heartbeat, resource fencing (STONITH), or the like. Cases of data that was not written to the disk at the time of the failure, at the FilePort 1002 side and/or at the FileCache 1003 side, may be handled.

In some embodiments, an XML-RPC implementation may be used in order to provide system API. Some embodiments may support SNMP authentication and/or SNMP version 3 or later, as well as logging. Some embodiments may divide the system to a generic WAN file system engine, and use activation rules based on application and usage patterns.

Some embodiments may split the synchronous DSFS engine to an asynchronous one. This may include management of a state between requests and responses, and also the ability to return with approximate answers to the user. It may also involve management of the data, since data may reside at different locations in the system.

Some embodiments may study different file types and different application behavior and make sure the system reads ahead files data before the user requests it, to save time.

Some embodiments may include an algorithm that will compute, at each point in time, the fastest path to the user data. It can decide on maximum compression, or none at all, enlarge or change priorities, calculate trade-offs between resources (e.g., bandwidth, CPU cycles, memory), etc.

Some embodiments may integrate mail and calendar collaboration, and/or print services. For example, one embodiment may integrate print queues management (such as CUPS and/or SAMBA) into the system, and add management interface, so the system may supply print queue management.

Some embodiments may enable maximum performance by fine tuning the system according to environment conditions, such as: exclusive shares, read only shares, read all shares, caching priorities, share change frequency.

In some embodiments, to support Novell's Native File Access (NFA), the system may use Pass-Through authentication (PTA) to delegate security enforcement responsibility to the CIFS server at the EFS 1001. The CIFS server validates the user credentials with the Domain Controller and only then grants the user access to a resource on the CIFS server. A benefit of the above may include full ACLs support, including file owner preservation, access rights, permissions hierarchy without changes of existing users, groups and

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by EFS 1001, FilePort 1002, FileCache 1003, client computer 1004, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
receiving from a remote site a request to access a first file having a plurality of blocks, said request having a pre-defined format encapsulating an original request of a client of a synchronous client-server system and in accordance with a pre-defined file system;
determining, for each of at least some of said plurality of blocks, a differential portion representing a difference between each said block and a corresponding block of a second file; and
sending said differential portion to said remote site.

2. The method of claim 1, comprising reconstructing said first file at said remote site based on said differential portion and said second file.

3. The method of claim 1, comprising identifying one or more blocks of said first file with a unique ID corresponding to a content of said one or more blocks.

4. The method of claim 1, comprising identifying one or more blocks of said first file with a hash value of the contents of said one or more blocks.

5. The method of claim 1, comprising receiving from said remote site a lock request when said remote site requests to modify said first file.

6. The method of claim 1, comprising determining whether said second file correlates to said first file based on a heuristic.

7. The method of claim 6, comprising monitoring a modification performed on said first file.

8. The method of claim 1, wherein said receiving comprises receiving from said remote site a request to access said first file using a global name space of said client-server system.

9. The method of claim 1, comprising receiving from said remote site a request for authentication using a pass-through challenge-response mechanism.

10. The method of claim 1, comprising processing a set of credentials for authentication.

11. The method of claim 1, comprising storing said differential portion in a directory for later retrieval of a version of said first file.

12. The method of claim 1, comprising setting a read-only access permission to a files is said remote site if said remote site is non communicating.

13. The method of claim 1, comprising storing in a cache at least one block of said second file.

14. A method comprising:
receiving from a remote site a request to access a first file, said request having a pre-defined format encapsulating an original request of a client of a synchronous client-server system and in accordance with a pre-defined file system;
determining, based on a heuristic, that said first file correlates to a second file having similar data;
determining a differential portion representing a difference between said first file and said second file; and
sending said differential portion to said remote site.

15. A system comprising:
a first computing platform having access to a first file and a second file, the first file having a plurality of blocks; and
a second computing platform having access to said first file,
wherein said first computing platform is able to receive from said second computing platform a request to access said second file, said request having a pre-defined format encapsulating an original request of a client of a synchronous client-server system and in accordance with a pre-defined file system,
wherein said first computing platform is able to determine, for each of at least some of said plurality of blocks, a differential portion representing a difference between each said block and a corresponding block of said second file,
and wherein said first computing platform is able to send said differential portion to said second computing platform.

16. The system of claim 14, wherein said second computing platform is able to reconstruct said second file based on said differential portion and said first file.

17. The system of claim 14, wherein said first computing platform is able to identify one or more blocks of said second file with a unique ID which corresponds to a content of said one or more blocks.

18. The system of claim 14, wherein said first computing platform is able to identify one or more blocks of said second file with a hash value of the contents of said one or more blocks.

19. The system of claim 14, wherein said first computing platform is able to receive from said second computing platform a lock request when said second computing platform requests to modify said second file.

20. The system of claim 14, wherein said first computing platform is able to determine whether said first file correlates to said second file based on a heuristic.

21. The system of claim 19, wherein said first computing platform is able to monitor a modification performed on said first file.

22. The system of claim 14, wherein said first file and said second file share a global name space.

23. The system of claim 14 wherein said first computing platform is able to receive from said second computing platform a request for authentication using a pass-through challenge-response mechanism.

24. The system of claim 14, wherein said first computing platform is able to receive from said second computing platform a set of credentials for authentication.

25. The system of claim 14, wherein said first computing platform is able to store said differential portion in a directory associated with an archived version of said second file.

26. The system of claim 14, comprising a cache to store at least one block of said first file.

27. A computing platform able to determine, based on a heuristic, that a first file correlates to a second file having similar contents, to calculate a differential portion representing a difference between said first file and said second file, and to send said differential portion to another computing platform.
